(19) United States
(12) Patent Application Publication
(10) Pub. No.: US 2025/0370781 A1
(43) Pub. Date: Dec. 4, 2025

(54) Abstraction Mechanism For Manipulating Fragmented Data

(71) Applicant: Oracle International Corporation, Redwood Shores, CA (US)

(72) Inventors: Aleksei Efimov, Dublin (IE); Daniel Jean-Michel Fuchs, Dublin (IE); Daniel Jelinski, Gdansk (PL); Jaikiran Pai, Dharwad (IN)

(73) Assignee: Oracle International Corporation, Redwood Shores, CA (US)

(21) Appl. No.: 19/084,287

(22) Filed: Mar. 19, 2025

Related U.S. Application Data
(60) Provisional application No. 63/654,509, filed on May 31, 2024.

(51) Int. Cl. G06F 9/455

(52) U.S. Cl. CPC G06F 9/45516

(57) ABSTRACT

Techniques are disclosed for abstracting multiple fragments of a dataset into a single abstraction that can be used to manipulate the fragmented dataset. Fragments of the dataset are represented in memory by multiple runtime objects generated by the system. The system abstracts the runtime objects by generating a single runtime object to represent the runtime objects. While the dataset remains fragmented, the single runtime object presents the fragmented dataset as a continuous sequence of elements. The system subsequently reads the continuous sequence of elements to decode the fragmented dataset. While reading an element in the continuous sequence of elements, the system may advance a read position of the single runtime object, and the system may advance a read position of an individual runtime object that represent that element. Once an element has been read through the single runtime object, that element may be released from the continuous sequence of elements.

### BENEFIT CLAIMS; RELATED APPLICATIONS; INCORPORATION BY REFERENCE

This application claims the benefit of U.S. Provisional Patent Application 63/654,509, filed on May 31, 2024, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to computer networking. In particular, the present disclosure relates to processing fragmented network data.

### BACKGROUND

A data stream is a sequence of related, digitally encoded signals that are transmitted through a communication network. A communication network is two or more devices that are communicatively coupled by at least one network link. Devices in a communication network may include one or more software devices (e.g., virtual machines, cloud-based applications, software-defined networking controllers, etc.), hardware devices (e.g., routers, switches, hubs, etc.), and/or devices that combine both software and hardware (e.g., smartphones, servers, IoT devices, etc.). Network links in a communication network may include one or more wireless network links and/or wired network links.

Typically, a data stream is associated with at least one communication protocol. A communication protocol is a set of rules that govern how information is transmitted through a communication network. Among other aspects of a data stream, a communication protocol may dictate how units of data within the data stream are formatted and organized. Example units of stream data that may be found within a data stream include network packets, protocol frames, segments, bytes, bits, and other units of stream data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture that techniques described herein may be practiced according to an embodiment;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 illustrates a system for practicing techniques described herein according to an embodiment;

FIG. 6 illustrates example operations for parsing stream data according to an embodiment;

FIG. 7 illustrates example operations for manipulating aggregated data according to an embodiment;

FIG. 8 illustrates example operations for aggregating data according to an embodiment;

FIG. 9 illustrates example operations for peeking aggregated data according to an embodiment;

FIG. 10 illustrates example operations for reading aggregated data according to an embodiment;

FIG. 11 illustrates example operations for releasing aggregated data according to an embodiment;

FIG. 12 illustrates an example network packet according to an example embodiment;

FIG. 13 illustrates example aggregated data according to an example embodiment; and

FIG. 14 is a block diagram that illustrates a computer system according to an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. STREAM DATA PARSING SYSTEM
4. PARSING STREAM DATA
5. DATA AGGREGATION TECHNIQUES
   5.1 AGGREGATING DATA
   5.2 PEEKING AGGREGATED DATA
   5.3 READING AGGREGATED DATA
   5.4 RELEASING AGGREGATED DATA
6. EXAMPLE EMBODIMENT
   6.1 EXAMPLE PACKET ARCHITECTURE
   6.2 EXAMPLE FRAME REPLACEMENT
7. HARDWARE OVERVIEW
8. MISCELLANEOUS; EXTENSIONS

### 1. General Overview

One or more embodiments (a) abstract multiple representations of a dataset that is arbitrarily fragmented into multiple data structures and (b) present the fragmented dataset as a continuous sequence of elements that can be manipulated through a single abstraction. As used herein, the term “element” refers to some unit of data. Example elements include a bit, a nibble, a byte, a short, an int, and others. While the dataset itself remains fragmented into the multiple data structures, the presentation of the fragmented dataset by the single abstraction as a continuous sequence of elements allows other components to manipulate the fragmented dataset as a whole, i.e., as though they were a single data item. Manipulating the fragmented dataset through the single abstraction allows other components of the system to process the fragmented dataset as a whole without having to handle the underlying complexity that is associated with reassembling the fragmented dataset from the multiple data structures.

One or more embodiments (a) abstract multiple representations of a dataset that is arbitrarily fragmented into multiple data structures and (b) present the fragmented dataset as a continuous sequence of elements that can be manipulated through a single abstraction that is referred to herein as a “buffers reader.” As used herein, the term “buffer” refers to an abstraction that serves as a temporary storage area (e.g., memory) used to hold data. Here, the multiple buffers are backed by the multiple data structures, i.e., organized and managed using the respective data structures. Once a fragment of the dataset is stored to an underlying data structure that backs a buffer, the buffer acts as a representation of the fragment of the dataset, and the buffer can be used to access and manipulate that fragment. However, a non-trivial amount of complexity may be associated with reassembling the fragmented dataset by interacting with the multiple buffers individually. To prevent other components of the system from having to deal with this complexity, the system aggregates the multiple buffers by entering the multiple buffers into a list of abstracted buffers maintained by the buffers reader. Once the multiple buffers are entered into the list of abstracted buffers, the buffers reader handles the complexity of manipulating the multiple buffers to access the fragmented dataset from the multiple data structures. While the dataset remains arbitrarily fragmented across the multiple data structures, the buffers reader presents the fragmented dataset as if the fragmented dataset were stored in a complete state to a single data structure and represented by a single buffer. Through the buffers reader, other components of the system can manipulate the fragmented dataset as if the fragmented dataset were represented by a single buffer, even though the size of the multiple fragments may exceed the capacity of any individual buffer.

One or more embodiments (a) receive a unit of stream data that is arbitrarily split into multiple fragments, (b) store the multiple fragments of the unit of stream data to multiple data structures backing multiple buffers, (c) enter the multiple buffers into a list of abstracted buffers maintained by a buffers reader, and (d) use the buffers reader to process the fragmented unit of stream data as a continuous sequence of elements. The continuous sequence of elements includes each element of the multiple data structures that stores part of the unit of stream data, and the continuous sequence of elements excludes any element of the multiple data structures that does not store a part of the unit of stream data. Despite the unit of stream data remaining fragmented across the multiple data structures, other components of the system are allowed to process the elements storing the unit of stream data as a whole, using methods provided by the buffers reader that hide the complexity of assembling the continuous sequence of elements from the multiple data structures. The continuous sequence of elements that stores the unit of stream data across the multiple data structures is organized by the buffers reader according to a single index. While the unit of stream data is processed through the buffers reader, the buffers reader may track the processing of the individual elements that store the unit of stream data across the multiple data structures with respect to both (a) the single index that applies to the continuous sequence of elements and (b) multiple relative indexes that are maintained by the multiple buffers. A component of the system may use methods of the buffers reader to (a) retrieve an element in the continuous sequence of elements, (b) write to elements in the continuous sequence of elements, (c) release elements from the continuous sequence of elements, and/or (d) perform various other operations.

One or more embodiments described in this Specification and/or recited in the claims may not be included in this General Overview section.

### 2. Architectural Overview

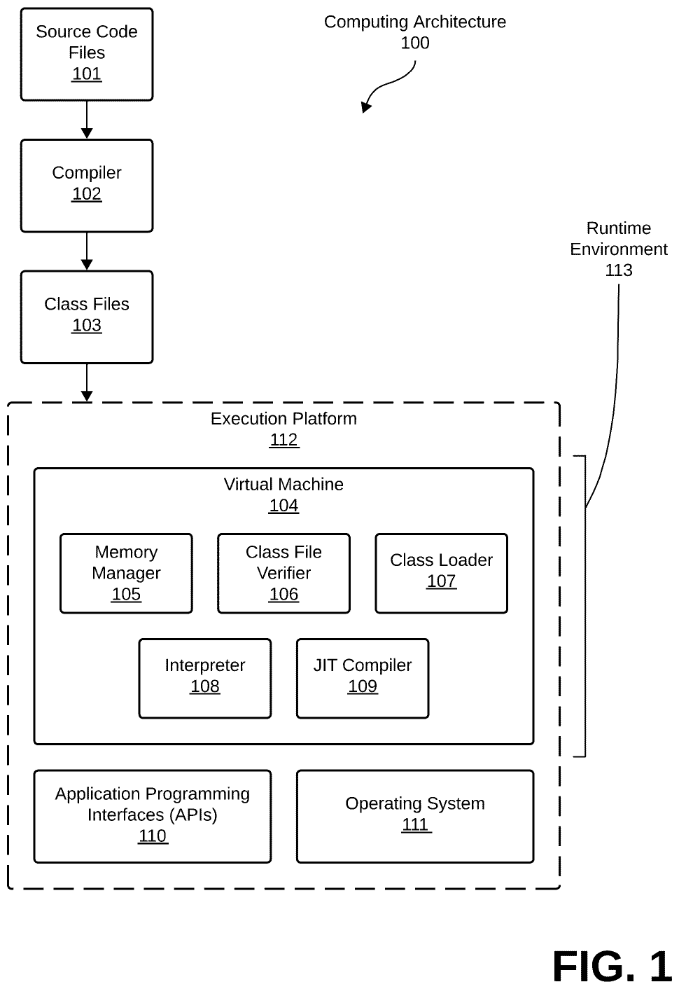

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent runtime performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the runtime performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

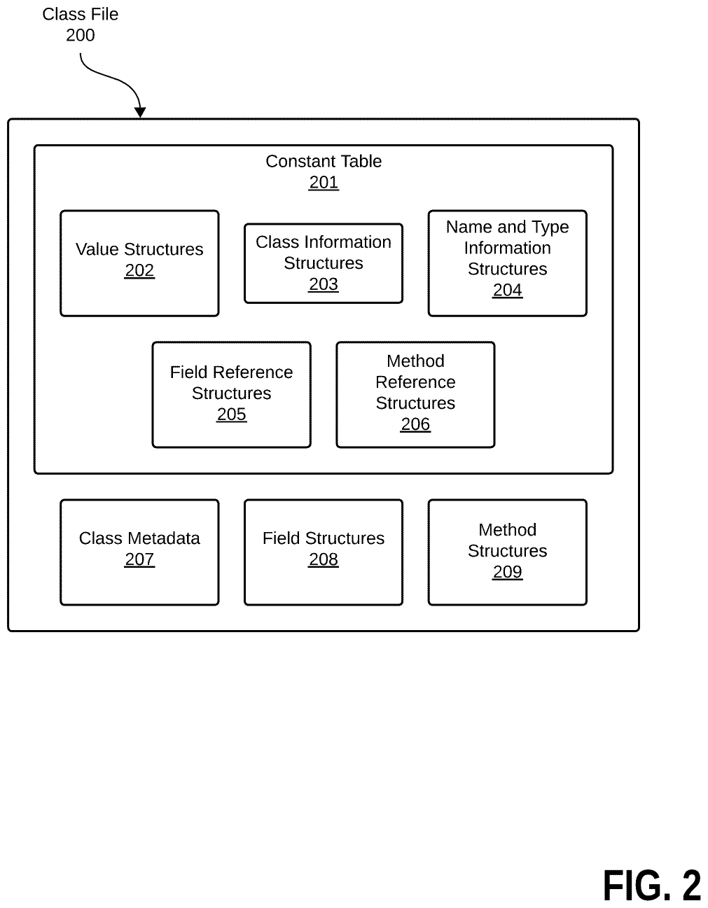

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g. “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:

```
class A
{
  int add12and13( ) {
    return B.addTwo(12, 13);
  }
}
```

In the above example, the Java method add12and13 is defined in class A, takes no parameters, and returns an integer. The body of method add12and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the runtime representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

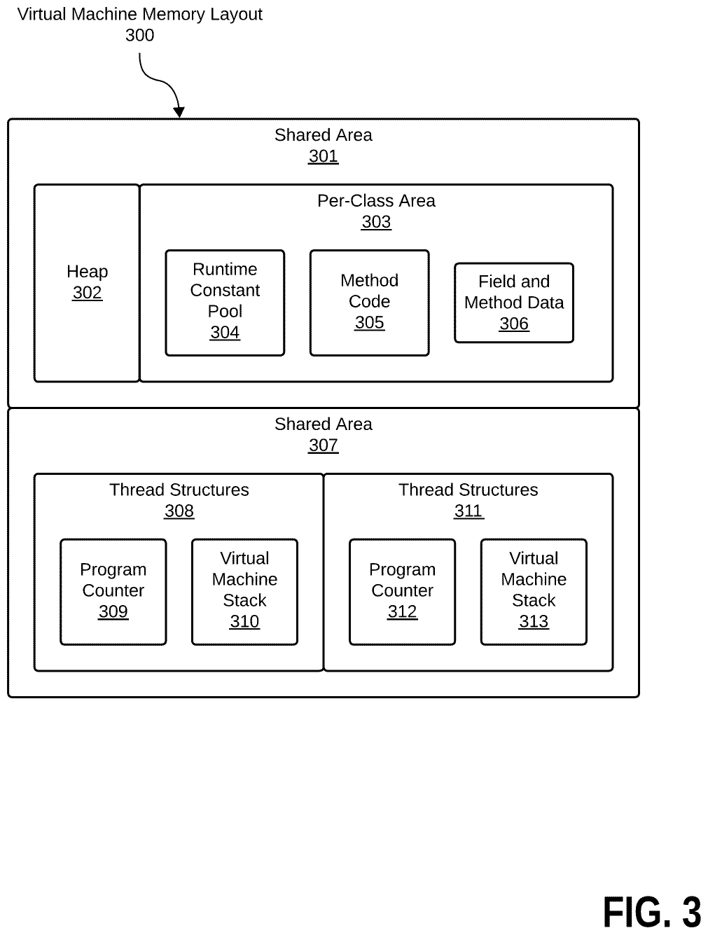

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the runtime data area from which memory for class instances and arrays is allocated. In an embodiment, the per-class area 303 represents the memory area where the data pertaining to the individual classes are stored. In an embodiment, the per-class area 303 includes, for a loaded class, a runtime constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

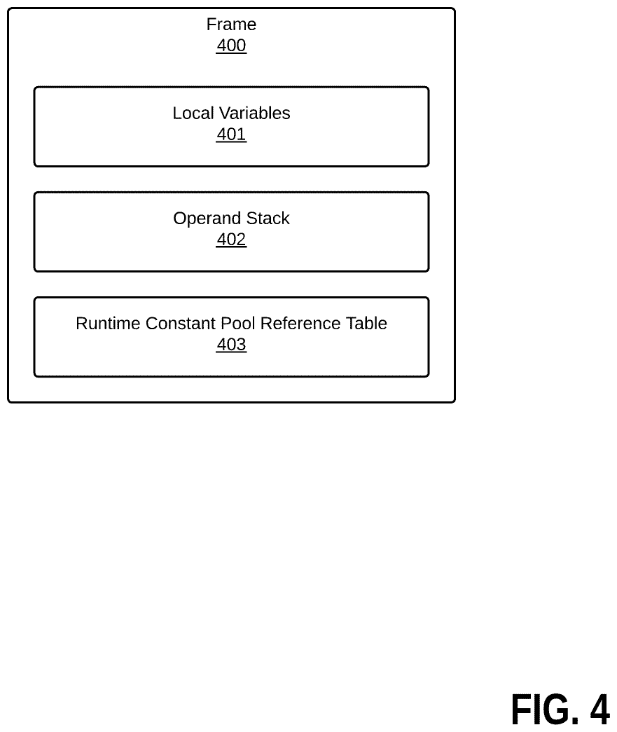

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and runtime constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the runtime constant pool reference table 403 contains a reference to the runtime constant pool 304 of the current class. The runtime constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the runtime location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the runtime constant pool 304, method code 305, and field and method data 306 for the class within the per-class area 303 of the virtual machine memory layout 300. Linking is the process of taking the in-memory representation of the class and combining it with the runtime state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the runtime constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the runtime constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the runtime constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. Stream Data Parsing System

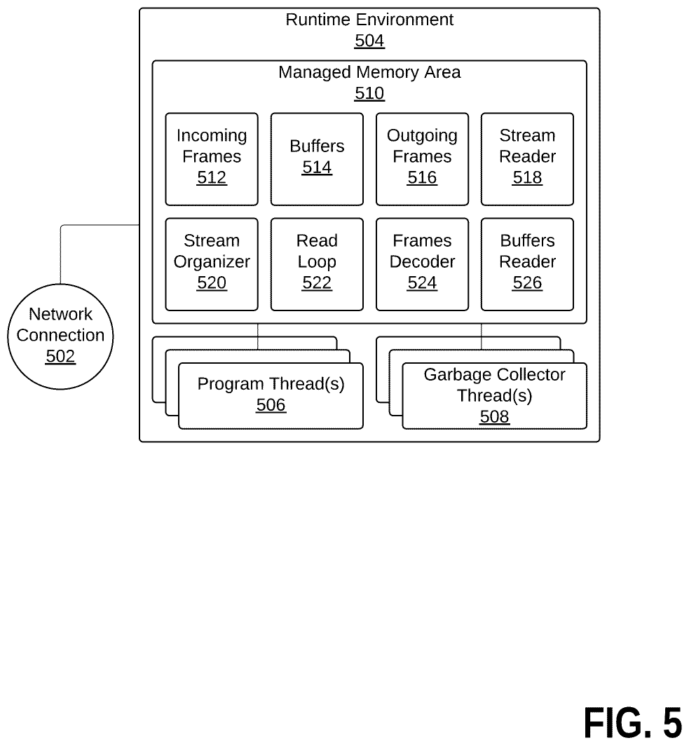

FIG. 5 illustrates a system 500 for practicing techniques described herein in accordance with one or more embodiments. As illustrated in FIG. 5, system 500 includes network connection 502 and runtime environment 504. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

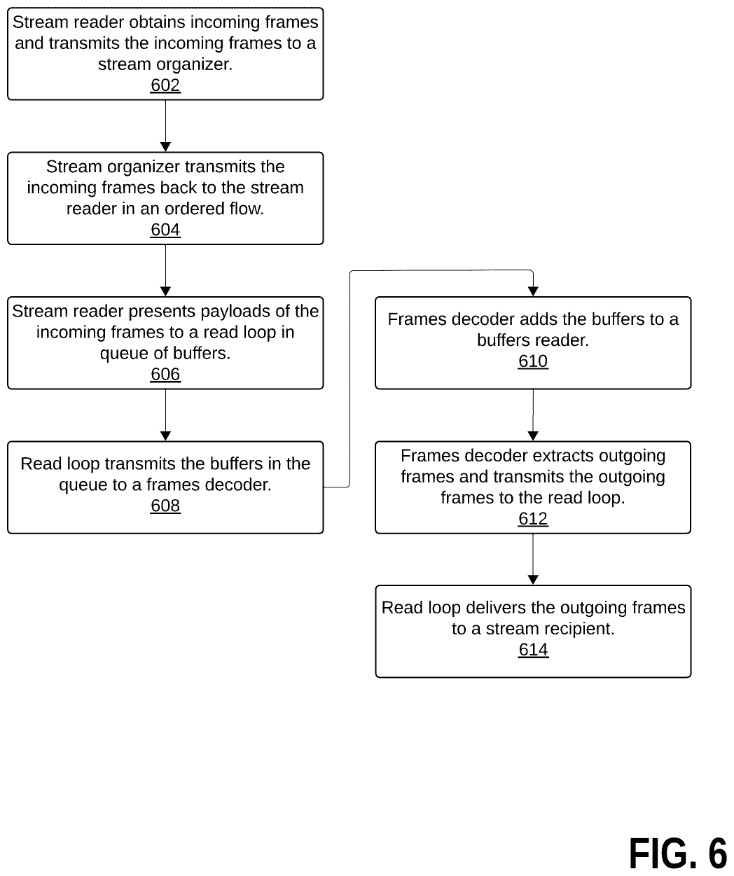

In one or more embodiments, system 500 refers to hardware and/or software configured to perform operations described herein for parsing stream data of one or more data streams. For brevity, a data stream may be referred to herein simply as a “stream.” Example operations for parsing stream data are described below with reference to FIG. 6. Additional embodiments and/or examples relating to parsing stream data are described within R01338NP, R01338N2, and R01338N4. The disclosures set forth by R01338NP, R01338N2, and R01338N4 are incorporated by reference in entirety as if set forth herein.

In an embodiment, network connection 502 is one or more network links of a communication network that is coupled to system 500. Network connection 502 delivers information to system 500, and/or network connection 502 transmits information from system 500. Network connection 502 includes physical link(s), and/or network connection 502 includes wireless link(s). The communication network that includes network connection 502 may be conceptualized in terms of layers of abstraction that model the flow of information within the communication network. As an example, consider the Open Systems Interconnection (OSI) model. The OSI model defines seven network layers. From lowest to highest, the seven network layers of the OSI model are (1) the physical layer, (2) the data link layer, (3) the network layer, (4) the transport layer, (5) the session layer, (6) the presentation layer, and (7) the application layer. For brevity, a layer of abstraction may be referred to herein simply as a “layer.”

In an embodiment, network connection 502 communicatively couples system 500 to at least one source of stream data. A source of stream data is local to a component of system 500, and/or a source of stream data is remote from a component of system 500. Furthermore, a source of stream data is located at the same physical site as a component of system 500, and/or a source of stream data is located a different physical site than a component of system 500. A source of stream data may be a component of system 500.

In an embodiment, network connection 502 is configured to transmit stream data in accordance with a single communication protocol, or network connection 502 is configured to transmit stream data system 500 in accordance with multiple communication protocols. For brevity, a communication protocol may be referred to herein simply as a “protocol.” Some protocols permit multiple streams to be established through a single network connection. Accordingly, depending on the protocol(s) associated with network connection 502, a single stream can be established through network connection 502, or multiple streams can be established through network connection 502.

In an embodiment, a protocol applicable to network connection 502 is associated with a single layer of a communication network that includes network connection 502, or the protocol is associated with multiple layers of the communication network. As used herein, the term “lower-layer protocol” refers to a protocol that is associated with lower-layer(s) of a communication network, and the term “higher-layer protocol” refers to a protocol that is associated with higher layer(s) of a communication network. In the context of the OSI model, for example, a lower-layer protocol is any communication protocol associated with at least one protocol that is not an application-layer protocol, and a higher-layer protocol is any protocol associated with at least one network layer that is not a physical-layer protocol. Network connection 502 may transmit stream data in accordance with physical-layer protocols, data-link-layer protocols, network-layer protocols, transport-layer protocols, session-layer protocols, presentation-layer protocols, application-layer protocols, and/or other protocols.

In an embodiment, network connection 502 is configured to transmit protocol frames to system 500, and/or network connection 502 is configured to transmit protocol frames from system 500. A frame pushed onto a virtual machine stack (e.g., virtual machine stack 310 or virtual machine stack 313) is distinct from a protocol frame. For brevity, a protocol frame may be referred to herein simply as a “frame.” Depending on the protocol(s) applicable to network connection 502, the frames transmitted through network connection 502 may be delivered to system 500 packaged within other units of stream data. In an example, network connection 502 delivers packets that are formatted according to one protocol, and these packets embed other packets that are formatted according to another protocol that is built on top of the one protocol. The other packets in this example embed frames that are formatted according to the other protocol. A protocol may define multiple types of frames that serve various purposes, and the protocol may specify different formats for the different frame types. Example frame types that may be defined by a protocol include authentication frames, data frames, connection control frames, acknowledgement frames, flow control frames, error control frames, management frames, handshake frames, synchronization frames, and others. A format for a frame that is specified by a protocol may dictate that the frame include a header, a payload, padding, a footer, and/or other components. If a frame includes a header, the header typically encodes frame metadata. For example, a header of a frame may specify a frame type, a stream ID, a frame offset, a frame length, and/or other information. In this example, the stream ID of the frame identifies a stream that the frame belongs to. The frame offset of the frame in this example indicates the position of the frame's payload within a stream, and the frame length of the frame indicates the size of the payload. One type of frame may carry a payload, and another type of frame may not carry a payload. A payload of a frame may carry other units of stream data. For example, the payloads of frames formatted according to one protocol (e.g., a lower-layer protocol) may encode other frames that are formatted according to another protocol (e.g., a higher-layer protocol).

In an embodiment, runtime environment 504 is a computing environment for executing one or more program instances. Runtime environment 504 provides resources for running program instance(s) and/or other processes that support the proper functioning of the program instance(s) and the wider runtime environment 504. Runtime environment 504 includes processing resources, and runtime environment 504 includes memory resources. As illustrated in FIG. 5, runtime environment 504 may include program thread(s) 506, garbage collector thread(s) 508, and managed memory area 510. An example runtime environment 504 typically includes various other resources that are not illustrated in FIG. 5.

In an embodiment, runtime environment 504 is implemented in the context of one or more class-based, object-oriented programming languages. Examples of class-based, object-oriented programming languages include Java, C++, C#, Python, Ruby, and others. The implementation of runtime environment 504 in the context of class-based, object-oriented program language(s) is described herein for illustrative purposes and is not intended to define any limits to the disclosure. The techniques described herein are equally applicable to other computing environments and other programming languages.

In an embodiment, program thread(s) 506 and garbage collector thread(s) 508 are threads of execution. A thread of execution is an independent execution environment for machine-level instructions. The runtime environment 504 of this embodiment includes multiple threads, or the runtime environment 504 includes a single thread. A thread may be a program thread 506 at one moment, and the thread may be a garbage collector thread 508 at another moment. A typical implementation of the Java Runtime Environment is one example of a multi-thread computing environment, and a typical implementation of the Java Card Runtime Environment is one example of a single-thread computing environment. A multi-thread computing environment is an example of a computing environment that is capable of performing concurrent operations. The implementation of runtime environment 504 as a threaded computing environment is described herein for illustrative purposes and is not intended to define any limits to this disclosure. The techniques described herein are equally applicable to other computing architectures.

In an embodiment, a program thread 506 is a thread of execution that is currently performing operations at the behest of a program instance. A program thread 506 is often manipulating information residing in managed memory area 510 while executing machine-level instructions associated with a program instance. For instance, while completing the requests of a program, a program thread 506 may be creating new data structures within managed memory area 510, reading from data structures residing in managed memory area 510, writing to data structures residing in managed memory area 510, and/or performing various other operations within managed memory area 510. An example program instance that is executed, at least in part, by a program thread 506 is configured to parse stream data delivered to system 500 through network connection 502.

In an embodiment, a garbage collector thread 508 is a thread of execution that is currently performing operations at the behest of a garbage collection process. As used herein, the term “garbage collection” refers to memory management. In the example context of runtime environment 504, a garbage collection process may be configured to reclaim memory allocated to data structures residing within managed memory area 510 that are no longer needed by a currently executing program instance. For instance, a garbage collector thread 508 may reclaim memory space allocated to data structures that were previously being used by a program instance to buffer stream data delivered to system 500 through network connection 502.

In an embodiment, managed memory area 510 is a data repository that serves, at least in part, as runtime memory for one or more program instances. In addition to including information that can be manipulated by a program instance, managed memory area 510 may include information that is not exposed at a program-level. A data repository is any type of storage unit and/or device (e.g., a file system, database, collection of tables, or any other storage mechanism) for storing data. Furthermore, a data repository may include multiple different storage units and/or devices. The multiple different storage units and/or devices of a data repository may or may not be of the same type or located at the same physical site. A data repository may be implemented in volatile memory, and/or the data repository may be implemented in persistent memory.

In an embodiment, information is represented within managed memory area 510 by runtime objects. A runtime object is a data structure that exists in memory while a program instance is currently executing. Generally, a runtime object is an abstraction of binary data that resides somewhere in low-level memory. For example, a runtime object may be an abstraction of binary data stored to main memory (e.g., random access memory). In the example illustrated by FIG. 3, a managed memory area 510 may be implemented within heap 302. In this example, the managed memory area 510 will typically include various other runtime objects that are not represented in FIG. 5. Managed memory area 510 is “managed” in the sense that managed memory area 510 may be subjected to a garbage collection process during runtime. For instance, an example garbage collection process is configured to reclaim memory space allocated to runtime objects residing in managed memory area 510. The example garbage collection process deems memory space allocated to a runtime object eligible for reclamation if that runtime object has become less than strongly reachable. A runtime object is strongly reachable if there is a chain of strong reference(s) that can be traversed by a program thread 506 to access that runtime object. In contrast, if there is no chain of strong reference(s) that can be traversed by a program thread 506 to access a runtime object, that runtime object is not strongly reachable. A runtime object being less than strongly reachable to a program thread 506 does not necessarily imply that the runtime object is unreachable to a program thread 506. For example, a runtime object that is not strongly reachable may remain reachable through a non-strong reference. An example strong reference is a default reference that is typically used to refer to a runtime object. An example non-strong reference is a special type of reference that is created by a reference object (e.g., a soft reference object, a weak reference object, a final reference object, a phantom reference object, a native weak reference object, etc.). Furthermore, the term “unreachable” is not necessarily synonymous with the term “inaccessible.” For example, a runtime object that is unreachable to a program thread 506 may remain accessible to a garbage collector thread 508. As used herein, the term “disposable” identifies information that is eligible for garbage collection, and the term “live” identifies information that is ineligible for garbage collection. A runtime object may provide access to a method that is defined by a reference type that is related to the runtime object. A runtime object may be described herein as performing an operation if a method (e.g., an instance method, a static method, etc.) defined by a related reference type is executed. As an example, consider an instance of a class that defines a method for writing to an object field, and assume that the method is called on the class instance. In this example, the class instance is said to “write to an object field” when a thread executes machine-level instructions corresponding to the operations defined in the method body of the method. A method need not be invoked for that method to be executed. If a method is invoked, the method is invoked explicitly, or the method is invoked implicitly.

In an embodiment, managed memory area 510 includes mechanisms for parsing stream data, and/or managed memory area 510 includes other information. As illustrated in FIG. 5, managed memory area 510 may include incoming frames 512, buffers 514, outgoing frames 516, stream reader 518, stream organizer 520, read loop 522, frames decoder 524, and/or buffers reader 526. Information describing incoming frames 512, buffers 514, outgoing frames 516, stream reader 518, stream organizer 520, read loop 522, frames decoder 524, and/or buffers reader 526 may be implemented across any of the components within system 500 (components illustrated in FIG. 5 and otherwise) (e.g., a per-class area, a virtual machine stack, local variables, an operand stack, etc.). However, this information is depicted by FIG. 5 solely within the bounds of managed memory area 510 for purposes of clarity and explanation.

In an embodiment, an incoming frame 512 is a protocol frame that represents stream data received by system 500 through network connection 502. An incoming frame 512 may be delivered to the system 500 as binary stream data that is formatted according to a protocol, and the incoming frame 512 may subsequently be manifested in managed memory area 510 as a higher-level abstraction of that binary data that is formatted according to a reference type. An incoming frame 512 is associated with a single protocol, or the incoming frame 512 is associated with multiple protocols. An incoming frame 512 may be associated with a lower-layer protocol, a higher-layer protocol, and/or another variety of communication protocol.

In an embodiment, an incoming frame 512 is associated with a lower-layer protocol. For instance, an incoming frame 512 may be associated with a transport-layer protocol. Example transport-layer protocols that may be associated with an incoming frame 512 include the following: the Transmission Control Protocol (TCP), the User Datagram Protocol (UDP), the QUIC Protocol, the Stream Control Transmission Protocol (SCTP), the Datagram Congestion Control Protocol (DCCP), the Reliable User Datagram Protocol (RUDP), and others. Recall that any given protocol may define different frame types that serve distinct purposes. Frame types of the QUIC Protocol, for example, include a stream frame, a crypto frame, a connection control frame, an acknowledgement frame, and others. The QUIC Protocol is built on top of the UDP, and the QUIC Protocol uses UDP to deliver the features of the QUIC Protocol. As an example, assume that a QUIC stream is established through network connection 502. In this example, network connection 502 may deliver datagrams to system 500. Datagrams are packets formatted according to the UDP. The UDP datagrams of this example embed other packets formatted according to the QUIC Protocol (i.e., QUIC packets). If a datagram embeds a QUIC packet in this example, the datagram embeds a single QUIC packet, or the datagram embeds multiple QUIC packets. The QUIC packets of this example may embed incoming frames 512 formatted according to the QUIC Protocol (i.e., QUIC frames). A QUIC packet of this example embeds a portion of a QUIC frame, a single QUIC frame, and/or multiple QUIC frames. In this example, the QUIC frames may, in turn, embed other frames that accord to a higher-layer protocol (e.g., an application-layer protocol). To provide consistent examples, the QUIC Protocol is used as an example at multiple points in this Detailed Description. These examples are provided for the reader's convenience and should not be interpreted as limiting the scope of one or more embodiments.

In an embodiment, an incoming frame 512 overlaps with another incoming frame 512. An incoming frame 512 is said to “overlap” with another incoming frame 512 if the data carried by that incoming frame 512 overlaps with the data carried by the other incoming frame 512. For example, if the payload of one incoming frame 512 carries stream data that also appears, at least in part, in the payload of another incoming frame 512, the one incoming frame 512 is said to overlap with the other incoming frame 512. Overlapping incoming frames 512 can be identified based on frame metadata. For example, the system 500 may identify two overlapping incoming frames 512 based on a comparison between the two incoming frames' (a) stream IDs, (b) frame offsets, and/or (c) frame lengths (e.g., by comparing frame offsets and frame lengths). The frame metadata that is used by the system 500 to identify overlaps between incoming frames 512 may vary depending on the protocol associated with the incoming frames 512, the frame type of the incoming frames 512, and other factors. If two incoming frames 512 partially overlap with one another, the system 500 may deem one of those two incoming frames 512 partially extraneous. The term “extraneous” is used herein to refer generally to any information that is redundant, unwanted, unneeded, outdated, or otherwise surplus to the intended purpose, context, or operation of the system.

In an embodiment, an incoming frame 512 is a duplicate of another incoming frame 512. Incoming frames 512 are referred to as “duplicates” if those incoming frames share at least some identical attributes. For example, an incoming frame 512 is referred to as a “duplicate” of another incoming frame 512 if both incoming frames 512 deliver the same payload. A duplicate incoming frame 512 need not be a frame that carries a payload. Duplicate incoming frames 512 can be identified based on frame metadata. For example, two incoming frames 512 that carry the same payload will specify the same stream ID, frame offset, and frame length. If two incoming frames 512 are duplicates of one another, the system 500 may deem one of those two incoming frames 512 fully extraneous.

In an embodiment, an incoming frame 512 is manifested in managed memory area 510 as a runtime object that is related to an incoming frames reference type. For instance, an incoming frame 512 may be manifested as an instance of an incoming frames class, or the incoming frame 512 may be manifested as an instance of a subclass that directly or indirectly extends the incoming frames class. Additionally, or alternatively, an incoming frame 512 may be manifested as an instance of a class that directly or indirectly implements an incoming frames interface. As an example, assume that an incoming frame 512 received through network connection 502 is a QUIC frame. The QUIC frame of this example is, more specifically, a stream frame that delivers a payload of stream data. In this example, the stream frame is manifested in managed memory area 510 as an instance of a stream frame class that extends a QUIC frames class (i.e., an incoming frames reference type). An incoming frame's 512 manifestation as a runtime object generally includes object field(s) that hold frame metadata. The frame metadata carried by object fields of an incoming frame may correspond to binary data that is carried by the header of that incoming frame 512. For example, the object fields of an incoming frame 512 may hold a frame type, a stream ID, a frame offset, a frame length, and/or other information. Additionally, or alternatively, frame metadata held by object fields of an incoming frame 512 may be derived from other sources of information, such as other incoming frames 512 that are constituents of the same stream, a packet that encapsulates the incoming frame 512, and so on. An incoming frames reference type may vary depending on the protocol(s) associated with the incoming frame 512, the frame type of the incoming frame 512 (e.g., an authentication frame, a frame carrying a payload of stream data, a connection control frame, etc.), and/or other factors. Accordingly, the object fields, instance methods, and other aspects of a runtime object manifesting an incoming frame 512 may also vary.

In an embodiment, a buffer 514 is an abstraction that serves as a mechanism for storing information in memory. For instance, a buffer 514 may act as a mechanism for storing stream data in memory, and/or the buffer 514 may serve as a mechanism for holding other information in memory. A buffer 514 may be configured to act as a storage mechanism for a specific primitive data type. Example buffers 514 include byte buffers 514, char buffers 514, double buffers 514, float buffers 514, int buffers 514, long buffers 514, short buffers 514, and others. In general, a buffer 514 is configured to provide other components of system 500 access to a dataset that is presented by the buffer 514.

In an embodiment, a buffer 514 is an abstraction that is backed by an underlying data structure, and the underlying data structure may, in turn, be backed by even lower-level data structures. An array is an example of an underlying data structure that may back a buffer 514. When a dataset is “stored” to a buffer 514, the binary data encoding that dataset is, in actuality, being stored to the underlying data structure that is backing the buffer 514. For example, when binary data is stored to a byte buffer 514, that binary data may be encoded into an underlying byte array that backs the buffer 514. An underlying data structure that backs a buffer 514 may reside in managed memory area 510, or the underlying data structure that backs a buffer 514 may reside outside of managed memory area 510 (e.g., in native memory).

In an embodiment, a buffer 514 provides methods for accessing data stored to the buffer 514. As an example, consider a byte buffer 514 that is backed by a byte array. In this example, the byte buffer 514 may provide methods for retrieving information from the byte array, writing to the byte array, clearing the byte array, modifying the byte order of the byte array, and performing other operations.

In an embodiment, a buffer 514 is backed by an underlying data structure, and the buffer 514 indexes elements that are both (a) included within the underlying data structure and (b) represented by the buffer 514. An example buffer 514 indexes elements starting from zero. As used herein, the term “element” refers herein to some unit of data. Example elements that may be indexed by a buffer 514 include bits, bytes, characters, integers, floats, shorts, longs, custom elements, and others. A data structure that backs a buffer 514 may include elements that are not represented by the buffer 514, and the data structure may index elements differently than the buffer 514. The location of an element with respect to the indexing of a buffer 514 that represents the element is referred to herein as the “relative position” of the element, and the location of an element with respect to the indexing of an underlying data structure that backs the buffer 514 and stores the element is referred to herein as the “local position” of the element. A difference between the relative position of an element and the local position of the element is referred to herein as an “array offset.” The relative position of an element represented by a buffer 514 is equal to the local position of that element plus the array offset.

In an embodiment, a buffer 514 maintains variable(s) that characterize (a) the buffers 514 and/or (b) elements represented by the buffers 514. Example variables that may be maintained by a buffers 514 include (a) an array offset, (b) a read position, (c) a limit, (d) a capacity, and (e) others. An array offset of a buffer 514 is specified with respect to the indexing of an array that backs the buffer 514. In other words, an array offset indicates the distance between the starting point of an array backing a buffer 514 and the first element represented by that buffer 514. If the array offset is zero, the indexing of the array will coincide with the indexing of the example buffer 514; however, if the array offset is a non-zero value, the indexing of the example buffer 514 will be staggered from the indexing of the array. The read position of a buffer 514 is the relative position of the element that should be read next. The limit of a buffer 514 is the relative position of the first element that should not be accessible through the buffer 514. For example, if the limit of a buffer 514 is five, the last element that should be accessible through the buffer 514 has a relative position of four. The capacity of the buffer 514 is the number of elements that are represented by the buffer 514. An element represented by a buffer 514 may be read, or the element may be unread. An element is referred to herein as a “read element” if the relative position of that element is less than the read position of a buffer 514 that represents that element. A buffer 514 is referred to herein as “fully read” if the buffer 514 does not represent any unread elements. For example, a buffer 514 is fully read if the read position of the buffer 514 matches the limit of the buffer 514. A buffer 514 is referred to herein as “partially read” if (a) at least one element represented by the buffer 514 has been read and (b) at least one element represented by the buffer 514 has not been read. As an example, assume that a buffer 514 indexes elements represented by the buffer 514 starting from zero. In this example, the buffer 514 is partially read if the read position of the buffer 514 is both (a) greater than zero and (b) less than the limit of the buffer 514. A buffer 514 is referred to herein as “fully unread” if no elements represented by the buffer 514 have been read (e.g., the read position of the buffer 514 is zero).

In an embodiment, a buffer 514 offers getter methods that are configured to return variables of the buffer 514. For instance, among other methods, an example buffer 514 offers a “position” method and a “limit” method. The position method of the example buffer 514 returns the read position of the example buffer 514, and the limit method of the example buffer 514 returns the limit of the example buffer 514. It should be noted that the example buffer 514 offers separate setter methods having these same names (i.e., “position” and “limit”) that can be used to alter the read position and limit of the example buffer 514. In addition, a buffer 514 may provide method(s) that determine other attributes of the buffer 514 based on variables maintained by the buffer 514. For instance, the example buffer 514 offers a “has remaining” method and a “remaining” method. The has remaining method of the example buffer 514 is a Boolean method that returns true if the example buffer 514 represents at least one unread element. The remaining method of the example buffer 514 is an integer method that returns the number of unread elements represented by the example buffer 514.

In an embodiment, a buffer 514 provides method(s) for reading element(s) represented by the buffer 514. As used herein, the phrase “reading through a buffer” 514 refers to retrieving element(s) represented by the buffer 514 and recording those element(s) as being read. An example buffer 514 (e.g., a byte buffer) offers a relative “get” method that can be used to read from the buffer 514. If the relative get method is invoked, the relative get method is configured to (a) return the element (e.g., a byte) that resides at the read position of the example buffer 514 and (b) increment the read position of the example buffer 514 by one element (e.g., one byte). The example buffer 514 may provide multiple relative get methods. For instance, the example buffer 514 may also provide a relative get method that can be used to read multiple elements.

In an embodiment, a buffer 514 offers method(s) for peeking elements represented by the buffer 514. As used herein, the phrase “peeking through a buffer” 514 refers to retrieving element(s) represented by the buffer 514 without recording those element(s) as being read. An example buffer 514 provides absolute “get” method(s) that can be used to peek through the example buffer 514. Executing an absolute get method of the example buffer 514 does not alter a read position of the example buffer 514.

In an embodiment, a buffer 514 offers setter methods for altering variables maintained by the buffer 514. For instance, among other methods, an example buffer 514 provides a “position” method for setting the read position of the example buffer 514 to a relative position that is specified as an input parameter, and the example buffer 514 provides a “limit” method for altering the limit of the example buffer 514 to a relative position specified as an input parameter.

In an embodiment, a buffer 514 provides method(s) for creating a new buffer 514. For example, a byte buffer 514 may provide methods for slicing the byte buffer object to create a new byte buffer 514, allocating a new byte buffer 514, duplicating the byte buffer 514, and performing other operations. An example slice method of a buffer 514 creates a new buffer 514 that is a shared subsequence of the buffer's 514. In other words, the example slice method creates a new buffer 514 that is backed by the same underlying data structure (e.g., a byte array object) as the original buffer 514. In contrast, an example allocate method of a buffer 514 can be used to create a new buffer 514 that is backed by a separate underlying data structure.

In an embodiment, a buffer 514 is a runtime object that is related to a buffer reference type. As an example, consider a byte buffer 514. In this example, the buffer reference type is a buffer class, and the byte buffer 514 is an instance of a byte buffer class that extends the buffer class. In this example, the byte buffer 514 may be backed by a byte array that is represented in managed memory are 510 by an array object. The buffer class also possesses other subclasses for other types of buffers 514 in this example.

In an embodiment, a buffer 514 stores the payload of an incoming frame 512. More specifically, a payload of an incoming frame 512 is stored to an underlying data structure that backs a buffer 514, and the buffer 514 serves as the payload's representation in managed memory area 510. An incoming frame's 512 payload is often the majority of the data that is delivered by the incoming frame 512; accordingly, the majority of the memory space that describes an incoming frame 512 may be allocated to the underlying data structure that store's the incoming frame's 512 payload.

In an embodiment, a buffer 514 serving as a representative of an incoming frame's 512 payload offers method(s) that can be used to manipulate the data delivered within the payload. For instance, if the payload of an incoming frame 512 is partially extraneous, that payload may be sliced or partitioned by calling a method on a representative buffer 514. Creating a new data item that includes part of another data item is referred to herein as “slicing” the other data item if the new data item is a shared subsequence of the other data item. Creating a new data item that includes part of another data item is referred to herein as “partitioning” the other data item if the new data item is created by copying that part of the other data item to another location in memory. As an example, assume that an incoming frame 512 delivers a payload of partially extraneous binary stream data to the system 500. In this example, the incoming frame's 512 payload is stored to a byte array that backs a byte buffer 514, and the byte buffer 514 represents the incoming frame's payload in managed memory area 510. The payload of this example can be sliced by calling a slice method on the byte buffer 514, and the payload can be partitioned by calling an allocate method on the byte buffer 514. Calling the slice method on the byte buffer 514 in this example may result in the creation of a new byte buffer 514 that is backed by the same byte array as the original byte buffer 514. In comparison, calling the allocate method on the byte buffer 514 in this example may result in the creation of a new byte buffer 514 that is backed by a newly allocated byte array. Different parts of a protocol frame may be stored in different sections of memory. As an example, consider an incoming frame 512 that delivers a payload. The payload of this example is represented by a buffer 514 that is backed by an underlying data structure storing the payload. In this example, the incoming frame 512 (i.e., a runtime object representing a protocol frame in managed memory 510) may be stored in a different section of memory than the buffer 514 and/or the payload. The phrase “slicing a protocol frame” may refer herein to slicing any part of that protocol frame. For example, calling a slice method on a buffer 514 that stores an incoming frame's 512 payload may be referred to as “slicing the incoming frame 512” even though the incoming frame 512 may be described in a section of memory that is separate from the section of memory that describes the payload. Similarly, partitioning any part of a protocol frame may be referred to as “partitioning that protocol frame.” For example, calling an allocate method on a buffer 514 that represent an incoming frame's 512 payload may be referred to herein as “partitioning the incoming frame 512.”

In an embodiment, an outgoing frame 516 includes stream data delivered by system 500 to a stream recipient. A stream recipient may reside within runtime environment 504, or a stream recipient may reside outside of runtime environment 504. A stream recipient is local to a component of system 500, and/or a stream recipient is remote from a component of system 500. A stream recipient is located at the same physical site as a component of system 500, and/or a stream recipient is located at a different physical site than a component of system 500. An outgoing frame 516 is associated with a single protocol, or an outgoing frame 516 is associated with multiple protocols. An outgoing frame 516 may be associated with lower-layer protocols, higher-layer protocols, and/or other protocols. In an example, an outgoing frame 516 is an incoming frame 512. In another example, an outgoing frame 516 is decoded from the payload of an incoming frame 512. If an outgoing frame 516 is delivered to system 500 embedded in other units of stream data, that outgoing frame 516 may be arbitrarily divided between multiple units of stream in a manner that will vary depending on the protocols involved in delivering that outgoing frame 516 to system 500.

In an embodiment, an outgoing frame 516 is associated with a higher-layer protocol (i.e., the outgoing frame 516 is a higher-layer frame). For instance, an outgoing frame 516 may be associated with an application-layer protocol. Example application-layer protocols that may be associated with an outgoing frame 516 include Hypertext Transfer Protocol (HTTP) (e.g., HTTP/1.0, HTTP/1.1, HTTP/2, HTTP/3, etc.), Hypertext Transfer Protocol Secure (HTTPS), File Transfer Protocol (FTP), Simple Mail Transfer Protocol (SMTP), Post Office Protocol version 3 (POP3), Internet Message Access Protocol (IMAP), Dynamic Host Configuration Protocol (DHCP), Domain Name System (DNS), Telnet, Secure Shell (SSH), Simple Network Management Protocol (SNMP), and others. In an example, outgoing frames 516 are HTTP/3 frames that are delivered to system 500 encoded into the payloads of QUIC stream frames (i.e., incoming frames 512). In this example, an HTTP/3 frame is embedded into a single QUIC stream frame, or the HTTP/3 frame is embedded into multiple QUIC stream frames. Upon delivery to system 500 in this example, the HTTP/3 frame is stored to a single buffer 514 (e.g., a byte buffer 514), or the HTTP/3 frame is stored to multiple buffers 514. To provide consistent examples, HTTP/3 is used as an example at multiple points in this Detailed Description. These examples are provided for the reader's convenience and should not be interpreted as limiting the scope of one or more embodiments.

In an embodiment, an outgoing frame 516 is manifested in managed memory area 510 as a runtime object that is related to an outgoing frame reference type. In an example, the outgoing frame reference type is an outgoing frame interface, and an outgoing frame 516 is manifested in managed memory area 510 as an instance of a class that directly or indirectly implements the outgoing frame interface. In another example, the outgoing frame reference type is an outgoing frame class, and an outgoing frame 516 is manifested in managed memory as an instance of a subclass that directly or indirectly extends the outgoing frame class. An outgoing frame's 516 manifestation as a runtime object may include object fields that hold frame metadata corresponding to binary data specified in a header of the outgoing frame 516 and/or another source of information. In general, the content of an outgoing frame 516 may vary depending on (a) a protocol associated with the outgoing frame 516, (b) a frame type of the outgoing frame 516, and/or (c) other factors.

In an embodiment, an outgoing frame 516 is related to an outgoing frame reference type, and the outgoing frame reference type offers method(s) that can be used to manipulate the outgoing frame 516. For example, the outgoing frame reference type may offer a static “decode” method that is configured to return an outgoing frame 516 that is decoded from a continuous sequence of elements presented by a buffers reader 526. The decode method of this example is configured to accept a buffers reader 526 and a predicate as input parameters. In this example, the predicate is a functional interface that is used by the decode method to determine if the frame type of an outgoing frame 516 presented by the buffers reader 526 is permissible. If the frame type of an outgoing frame 516 is permissible, the decode method of this example typically (a) returns the outgoing frame 516 modeled as a complete frame, (b) returns the outgoing frame 516 modeled as a partial frame, or (c) returns null if the continuous sequence of elements does not include sufficient information to decode the outgoing frame 516. If the frame type of an outgoing frame 516 is not permissible, the decode method of this example typically returns the outgoing frame 516 modeled as a malformed frame.

In an embodiment, an outgoing frame 516 is modeled as a complete frame. If an outgoing frame 516 is modeled as a complete frame, delivery of the outgoing frame 516 typically begins after the entirety of the outgoing frame 516 is decoded. Outgoing frames 516 that deliver fixed-length payloads are often modeled as complete frames. Examples of HTTP/3 frames that may be modeled as complete frames include (a) settings frames, (b) go away frames, (c) cancel push frames, (d) max push ID frames, and (e) others. In an example, an outgoing frame 516 is manifested in managed memory area 510 as a complete frame by an instance of a complete frame subclass that corresponds to the frame type of the outgoing frame 516. For instance, the complete frame subclass of this example may be (a) a settings frame subclass, (b) a go away frame subclass, (c) a cancel push frame subclass, (d) a max push ID frame subclass, or (e) another subclass. In this example, the complete frame subclass offers a static “decode frame” method that can be used to create a new complete frame of the frame type corresponding to the subclass. The decode frame method of this example accepts a buffers reader as an input parameter. If the decode frame method of this example is invoked, the decode frame method is configured to attempt to decode a new complete frame from a continuous sequence of elements presented by the buffers reader that was specified as an input parameter to the invocation of the decode frame method.

In an embodiment, an outgoing frame 516 is modeled as a partial frame. If an outgoing frame 516 is modeled as a partial frame, the system 500 may begin delivery of data included in the outgoing frame 516 before the outgoing frame 516 is fully decoded. Examples of HTTP/3 frames that may be modeled as partial frames include (a) headers frames, (b) data frames, (c) push promise frames, (d) HTTP/3 frames with unknown frame types, and (e) others. In an example, an outgoing frame 516 is manifested in managed memory area 510 as a partial frame by an instance of a partial frame subclass (i.e., a subclass of a partial frame class), and the partial frame subclass corresponds to the frame type of the partial frame. For instance, the partial frame subclass of this example may be (a) a headers frame subclass, (b) a data frame subclass, (c) a push promise frame subclass, (d) an unknown frame subclass, or (e) another partial frame subclass.

In an embodiment, an outgoing frame 516 is modeled as a partial frame, and the partial frame maintains variable(s) that track the state of the outgoing frame's 516 payload. As an example, assume that an outgoing frame 516 is encoded into bytes that are abstracted by byte buffer(s). In this example, the partial frame maintains a streaming length variable, a remaining variable, and/or other variables. The streaming length variable of this example measures the number of bytes that encode the outgoing frame's 516 payload, and the remaining variable of this example measures the number of bytes encoding the outgoing frame's 516 payload that have not yet been delivered to a stream recipient. In this example, the partial frame offers a “streaming length” method that is configured to return the value stored in the streaming length variable, and the partial frame offers a “remaining” method that is configured to return the value stored in the remaining variable. The partial frame of this example also offers a “next payload bytes” method that is configured to accepts a buffers reader 526 as an input parameter. In this example, the next payload bytes method of the partial frame is configured to return any bytes encoding payload data of the outgoing frame 516 that (a) have not already been delivered to a stream recipient and (b) are presently available for decoding. The next payload bytes of the partial frame of this example returns these bytes as a list of byte buffers that abstract these bytes. In addition, the next payload bytes method of this example is configured to update a read position of a buffers reader 526 to reflect the retrieval of any bytes that encode payload data of the outgoing frame 516.

In an embodiment, an outgoing frame 516 is modeled as an unknown frame. An unknown frame is a partial frame that models an outgoing frame 516 with an unknown frame type. In an example, the system determines if the frame type of an outgoing frame 516 is a known frame type by executing a static “for type” method that is offered by a frame type class while specifying the frame type of the outgoing frame 516 as an input parameter. In this example, the frame type class also offers a static “max length” method that can be invoked to determine a maximum length associated with a frame type. It should be noted that some protocols (e.g., HTTP/3) dictate that protocol frames with unknown frame types can be ignored; therefore, the payload of an outgoing frame 516 with an unknown frame type can safely be discarded in some scenarios. As used herein, the phrase “discarding a dataset” refers to rendering memory space allocated for storing that dataset eligible for reclamation. In an example, an outgoing frame 516 is manifested in managed memory area 510 as an unknown frame by an instance of an unknown frame class. In this example, the unknown frame class is a subclass of a partial frame class.

In an embodiment, an outgoing frame 516 is modeled as a malformed frame. An outgoing frame 516 may be modeled as a malformed frame if the outgoing frame 516 is found to possess some malformity. An example malformed frame includes (a) frame metadata of an outgoing frame 516 and (b) an error code indicating a malformity associated with the outgoing frame 516. A malformed frame can be used to trigger a protocol error that will (a) terminate a stream, (b) terminate a network connection that is used to establish the stream, and/or (c) cause other actions. In an example, an outgoing frame 516 is manifested in managed memory area 510 as a malformed frame as an instance of a malformed frame subclass.

In an embodiment, a stream reader 518 is a mechanism for processing incoming stream data. A stream reader 518 is configured to process incoming stream data by manipulating incoming frames 512, buffers 514, and/or other information. A stream reader 518 is configured for parsing incoming frames 512 associated with a particular protocol, or the stream reader 518 is configured for parsing incoming frames 512 that are associated with multiple protocols. A stream reader 518 is configured for parsing incoming frames 512 associated with a single stream, or the stream reader 518 is configured for parsing the incoming frames 512 of multiple streams. In an example, a stream reader 518 is configured to obtain incoming frames 512 from a remote peer, transmit the incoming frames 512 to a stream organizer 520, receive the incoming frames 512 transmitted back to the stream reader 518 by the stream organizer 520, present the payloads of incoming frames 512 in a queue of buffers 514, trigger a read loop 522 to consume the payloads presented in the queue of buffers 514, and perform other operations.

In an embodiment, a stream reader 518 is a runtime object that is related to a stream reader reference type. As an example, assume that incoming frames 512 are QUIC frames. In this example, a stream reader 518 is an instance of a QUIC receiver stream implementation class. The QUIC receiver stream implementation class of this example extends a QUIC stream class, and the QUIC stream class implements a QUIC receiver stream interface.

In an embodiment, a stream reader 518 maintains a queue of buffers 514. A queue of buffers 514 maintained by a stream reader 518 includes buffers 514 that store payloads of incoming frames 512. In particular, the buffers 514 listed in a queue of buffers 514 correspond to incoming frames 512 that the stream organizer 520 has transmitted back to the stream reader 518 in an ordered flow. In other words, the buffers 514 listed in this queue correspond to incoming frames 512 that the stream organizer 520 has released for further processing. In an example, a stream reader 518 organizes a queue of buffers 514 according to the same order that a stream organizer 520 transmits the corresponding incoming frames 512 back to the stream reader 518.

In an embodiment, a stream reader 518 provides methods for interacting with incoming frames 512, buffers 514, and other information. For example, a stream reader 518 may provide a method for processing incoming frames, a method for polling buffers 514 from an ordered queue of buffers 514 maintained by the stream reader 518, and other methods.

In an embodiment, stream organizer 520 is a mechanism for organizing stream data. Stream organizer 520 is configured to organize stream data by manipulating incoming frames 512 and/or other information. Stream organizer 520 is configured for parsing incoming frames 512 associated with a particular protocol, or stream organizer 520 is configured for parsing incoming frames 512 associated with multiple protocols. Stream organizer 520 is configured for parsing incoming frames 512 associated with a single stream, or stream organizer 520 is configured for parsing incoming frames 512 of multiple streams. In an example, a stream organizer 520 is configured to receive incoming frames 512 from a stream reader 518, and the stream organizer 520 is configured to transmit the incoming frames 512 back to the stream reader 518 in an ordered flow. The stream organizer 520 of this example is configured to organize the incoming frames 512 by reordering the incoming frames 512, discarding duplicate incoming frames 512, and eliminating overlaps between incoming frames 512.

In an embodiment, a stream organizer 520 provides methods for manipulating incoming frames 512, buffers 514, and/or other information. For example, a stream organizer 520 may provide a method for receiving incoming frames 512, a method for polling incoming frames 512 from the stream organizer 520 that the stream reader 518 may call to obtain any frame payload that is ready for delivery, a method for extracting frame offsets, a method for extracting frame lengths, a method for slicing incoming frames 512, a method for allocating new incoming frames 512, and other methods. A method of a stream organizer 520 may invoke another method on a buffer 514, an incoming frame 512, another runtime object, or a reference type (i.e., a static method). As an example, assume that a stream organizer 520 provides a slice method. The slice method of this example accepts one incoming frame 512 as an input parameter, and the slice method returns a new incoming frame 512 that can be used to replace the one incoming frame 512. In this example, calling the slice method on the stream organizer 520 may trigger the invocation of a slice method on a buffer 514 that represents a payload of the one incoming frame 512. The slice method of the buffer 514 will return a new buffer 514 that represents a portion of the one incoming frame's 512 payload, and the new incoming frame 512 will refer to the new buffer 514 in this example.

In an embodiment, stream organizer 520 offers a method that is configured to selectively replace incoming frames 512. In particular, the method is configured to generate a new incoming frame 512 to replace an existing incoming frame 512 if part of the data delivered to the system 500 by the existing incoming frame 512 is extraneous. There are multiple ways that a new incoming frame 512 can be created. Accordingly, the method offered by stream organizer 520 is configured to create a new incoming frame 512 in a manner that bests suits the present circumstances.

In an embodiment, a method of stream organizer 520 is configured to replace (a) an incoming frame 512 and buffer 514 that stores the incoming frame's 512 payload with (b) a new incoming frame 512 and a new buffer 514 that stores the new incoming frame's 512 payload. As an example, consider an original incoming frame 512 and an original buffer 514 that stores the original incoming frame's 512 payload. In this example, a method of stream organizer 520 instantiates a new incoming frame 512 to replace the original incoming frame 512, and the method of stream organizer 520 instantiates a new buffer 514 by either (a) slicing the original buffer 514 or (b) partitioning the original buffer 514. To slice the original buffer 514 in this example, the method of stream organizer 520 is configured to call a slice method on the original buffer 514. To partition the original buffer 514 in this example, the method of stream organizer 520 is configured to call an allocate method on the original buffer 514.

In an embodiment, a stream organizer 520 maintains an ordered queue of frames 512 and a flow offset. An ordered queue of frames 512 maintained by a stream organizer 520 holds incoming frames 512 that are not yet ready to be returned to a stream reader 518 for further processing. A flow offset tracked by a stream organizer 520 is an indicator of the incoming frames 512 of a stream that have been returned by the stream organizer 520 to a stream reader 518 thus far. In general, a stream organizer 520 is configured to return an incoming frame 512 to a stream reader 518 when the frame offset of that incoming frame 512 matches the flow offset maintained by the stream organizer 520. When a stream organizer 520 receives an incoming frame 512 that indicates a frame offset that is greater than a current flow offset, the stream organizer 520 may add that incoming frame 512 to an ordered queue of frames 512 maintained by the stream organizer 520. When a stream organizer 520 transmits an incoming frame 512 back to a stream reader 518, the stream organizer 520 is configured to increment a flow offset commensurate to a frame length indicated by that incoming frame 512.

In an embodiment, a stream organizer 520 is a runtime object that is related to an ordered flow reference type. As an example, assume that the ordered flow reference type is an ordered flow class, and further assume that incoming frames 512 are QUIC frames. The QUIC frames of this example may include crypto frames, stream frames, and other types of QUIC frames. In this example, the ordered flow class implements a QUIC frame class, and the stream organizer 520 is an instance of a subclass that extends the ordered flow class. For instance, the stream organizer 520 of this example may be an instance of a crypto data flow class that extends the ordered flow class, an instance of a stream data flow class that extends the ordered flow class, or an instance of another subclass that extends the ordered flow class. In this embodiment, a flow offset for a stream is stored to an object field of a stream organizer 520, and an ordered queue of frames maintained by the stream organizer 520 may be a separate runtime object that is manipulated by the stream organizer 520. For example, an ordered queue of frames may be manifested as an instance of a concurrent skip list set class.

In an embodiment, a read loop 522 is a mechanism for processing outgoing stream data. A read loop 522 is configured to process outgoing stream data by manipulating outgoing frames 516, buffers 514, and/or other information. A read loop 522 is configured for processing outgoing frames 516 associated with a particular protocol, or the read loop 522 is configured for parsing outgoing 516 frames associated with multiple protocols. A read loop 522 is configured for processing the outgoing frames 516 of a single stream, or the read loop 522 is configured for processing the outgoing frames 516 of multiple streams.

In an embodiment, a read loop 522 is a runtime object that is related to a read loop reference type. As an example, assume that outgoing frames 516 are manifestations of HTTP/3 frames. In this example, the read loop is an instance of an HTTP/3 exchange implementation class, and the HTTP/3 implementation class extends an HTTP/3 stream class.

In an embodiment, a read loop 522 provides method(s) for processing stream data. An example method offered by a read loop 522 for processing stream data is configured to (a) facilitate the processing of stream data by other components of system 500 and (b) deliver the processed stream data to stream recipient(s). For instance, the example method for processing stream data may be configured to (a) poll buffers 514 from a queue of buffers 514 maintained by a stream reader 518, (b) submit the polled buffers 514 to a frames decoder 524 for decoding, (c) poll the frames decoder 524 for outgoing frames 516 decoded by the frames decoder 524, (d) query the frames decoder 524 for payload data of a decoded partial frame, (e) deliver decoded data of outgoing frames 516 to stream recipient(s), and/or (f) perform other operations. Data of an outgoing frame 516 that may be delivered to a stream recipient by the example method for processing stream data may include (a) payload data of the outgoing frame 516, (b) frame metadata of the outgoing frame 516, (c) and/or other information (e.g., an error code associated with a malformed frame). The example method for processing stream data may be configured to identify an appropriate stream recipient for decoded data of an outgoing frame 516 based on (a) the frame type of the outgoing frame 516, (b) how the outgoing frame 516 is modeled (e.g., partial frame, complete frame, malformed frame, etc.), (c) the content of the outgoing frame 516, and (d) other information.

In an embodiment, a read loop 522 offers a method for processing stream data, and the method for processing stream data is configured to deliver stream data to stream recipient(s). In an example, incoming frames 512 are QUIC frames that embed HTTP/3 frames (i.e., outgoing frames 516). In this example, a read loop 522 offers a “process QUIC data” method, and the process QUIC data method is configured to deliver stream data to one or more stream recipients. Stream recipient(s) of this example may include an HTTP response subscriber, a connection handler, a stream manager, a connection-level push handler, and others. Typically, if an outgoing frame 516 is an HTTP/3 data frame, the process QUIC data method of this example will attempt to deliver payload data of the HTTP/3 data frame to one or more HTTP response subscribers. Example HTTP response subscribers include web browsers, API clients, media players, server-sent events clients, web sockets, file downloaders, machine learning pipelines, and others. The process QUIC data method of this example is configured to deliver payload data of an HTTP/3 data frame to an HTTP response subscriber by (a) adding that payload data to a queue of stream data and (b) pushing the data in the queue of stream data to the HTTP response subscriber. In this example, the queue of stream data is manifested in managed memory area 510 as an instance of a concurrent linked queue class, and payload data of an HTTP/3 data frame is manifested in managed memory area 510 as a list of byte buffers (e.g., an instance of a class that implements a list interface). In this example, the concurrent linked queue instance offers an “add” method, and the process method of the read loop 522 is configured to add the stream data to the queue of stream data by invoking the add method on the concurrent linked queue instance while specifying a list of byte buffers as an input parameter. Furthermore, in this example, read loop 522 offers a “push response data” method that is configured to push data in the queue of stream data to an HTTP response subscriber if that HTTP response subscriber is ready to consume that data. After adding the stream data to the queue of stream data in this example, the process QUIC data method is configured to invoke the push response data method of the read loop 522.

In an embodiment, a frames decoder 524 is a mechanism for decoding stream data. In particular, a frames decoder 524 is a mechanism for decoding stream data delivered to the system in incoming frames 512. For instance, a frames decoder 524 may extract outgoing frames 516 from the payloads of incoming frames 512. To this end, a frames decoder 524 is configured to manipulate buffers 514, a buffers reader 526, and/or other information. A frames decoder 524 is configured for extracting outgoing frames 516 associated with a particular protocol, or the frames decoder 524 is configured for extracting outgoing frames 516 associated with multiple protocols. A frames decoder 524 is configured for extracting outgoing frames 516 of a single stream, or the frames decoder 524 is configured for extracting outgoing frames 516 of multiple streams. In an example, a frames decoder 524 is configured to accept buffers 514 from read loop 522, submit the buffers 514 to a buffers reader 526, decode stream data aggregated by the buffers reader 526 to generate outgoing frames 516, and transmit the outgoing frames 516 to the read loop 522.

In an embodiment, a frames decoder 524 provides methods for manipulating buffers 514, outgoing frames 516, and/or other information. For example, a frames decoder 524 may provide a method for submitting buffers 514 to the frames decoder 524, a method for polling outgoing frames 516 from the frames decoder 524, a method for retrieving data from a buffers reader 526, and other methods. An example poll method called on a frames decoder 524 returns a complete frame, a partial frame, an unknown frame, a malformed frame, or another variety of outgoing frame 516. The example poll method may call a static decode method of an outgoing frame reference type (e.g., an outgoing frames interface).

In an embodiment, a frames decoder 524 is a runtime object that is related to a frames decoder reference type. In an example, a frames decoder 524 is an instance of a frames decoder class. The frames decoder 524 of this example may be created by calling a static method of the frames decoder class.

In an embodiment, a frames decoder 524 maintains variable(s) for tracking the decoding of a stream. An example frames decoder 524 maintains a partial frame instance variable. The partial frame instance variable of the example frames decoder 524 indicates if there is an outgoing frame 516 modeled as a partial frame that is currently being decoded. Typically, the partial frame instance variable is either (a) set to reference an outgoing frame 516 modeled as a partial frame or (b) set to null. If the partial frame instance variable refers to an outgoing frame 516 in this example, that outgoing frame 516 is the partial frame that is currently being decoded. Alternatively, if the partial frame instance variable is set to null in this example, there is no partial frame that is currently being decoded. An outgoing frame 516 that is referenced by a partial frame instance variable of a frames decoder 524 is referred to herein as a “current partial frame.”

In an embodiment, a frames decoder 526 offers method(s) for retrieving elements that encode the payload of an outgoing frame 516. An example frames decoder 526 offers a “read payload bytes” method that can be used to retrieve undelivered payload data of an outgoing frame 516 modeled as a partial frame. If the payload of an outgoing frame 516 that is the current partial frame has not been fully decoded when the read payload bytes method is invoked, the read payload bytes method is configured to return the undelivered bytes encoding the payload that are presently available for decoding. The read payload bytes method is configured to return these bytes as a list of byte buffer(s).

In an embodiment, a buffers reader 526 is a mechanism configured to act as an abstraction of one or more buffers 514. While serving as an abstraction of buffer(s) 514, a buffers reader 526 presents the elements represented by those buffer(s) 514 as a continuous sequence of element(s) that can be accessed and manipulated through the buffers reader 526. A buffers reader 526 is configured to serve as an abstraction of a particular variety of buffers 514 (e.g., a byte buffers 514), or a buffers reader 526 is configured to serve as an abstraction of multiple varieties of buffers 514. A buffers reader 526 is a single buffers reader 526, or the buffers reader 526 is a list buffers reader 526. As the name suggests, a single buffers reader 526 is configured to act as an abstraction of a single buffer 514. A list buffers reader 526 is configured to act as an abstraction of one or more buffers 514. A list buffers reader 526 maintains a list of abstracted buffers 514, and the list buffers reader 526 acts as an abstraction of any buffers 514 that are entered into the list.

In an embodiment, a buffers reader 526 is a runtime object that is related to a buffers reader reference type. A buffers reader reference type and/or subclasses of the buffers reader reference type define methods (e.g., factory methods, constructors, etc.) that can be invoked to create a buffers reader 526. In an example, the buffers reader reference type is an abstract buffers reader class, and a buffers reader 526 is an instance of a subclass that extends the abstract buffers reader class. In particular, the buffers reader 526 of this example is an instance of a single buffers reader subclass that extends the buffers reader class, or the buffers reader 526 is an instance of a list buffers reader subclass that extends the buffers reader class.

In an embodiment, a buffers reader 526 acting as an abstraction of buffer(s) 514 presents elements represented by those buffer(s) 514 as a continuous sequence of element(s) that are consecutively indexed. An example continuous sequence of elements is indexed by a buffers reader 526 starting from zero. The index assigned to an element by a buffers reader 526 is referred to herein as the “global position” of that element. It should be noted that the indexing of an element by a buffers reader 526 may differ from how that same element is indexed by (a) a buffer 514 that represents that element and/or (b) an underlying data structure that stores that element. In other words, the global position of an element may differ from (a) the relative position of that element and/or (b) the local position of that element. A differential between the global position of an element and the relative position of the element is referred to herein as an “index differential.” For example, a differential between an index value assigned to an element by a buffers reader 526 and an index value assigned to that same element by a buffer 514 that is aggregated by the buffers reader 526 may be identified herein as the “index differential” of that buffer 514.

In an embodiment, a buffers reader 526 is a list buffers reader 526, and the buffers reader 526 maintains a list of abstracted buffers 514. An entry in a list of abstracted buffers 514 may record attributes of the buffer 514 corresponding to that entry. An example list of abstracted buffer 514 is indexed starting from zero where list index zero corresponds to the leading entry in the example list of abstracted buffers 514. It should be noted that the indexing of entries in a list of abstracted buffers 514 is separate from the indexing of elements in a continuous sequence of elements. An example entry in a list of abstracted buffers 514 is an instance of a record class, and the example entry includes (a) a reference to a buffer 514 that corresponds to the example entry, (b) an initial read position of that buffer 514, (c) a limit of that buffer 514, and/or (d) other information. Generally, the initial read position of a buffer 514 entered in a list of abstracted buffers 514 is the read position of that buffer 514 at the time that buffer 514 is entered into the list; however, this may not always be the case. For example, the leading entry in a list of abstracted buffers 514 may record the initial read position of the corresponding buffer 514 as zero even if the true read position of that buffer 514 is not zero at the time the buffer 514 is entered into the list. It should be noted that whether or not a buffer 514 entered into a list of abstracted buffers 514 possesses an index differential greater than zero may depend on where that buffer 514 is entered within the list. A preceding buffer 514 in a list of abstracted buffers 514 will typically contribute to the index differential of a latter buffer 514 in the list. As used herein, the “relative offset” of a buffer 514 included in a list of abstracted buffers 514 refers to an increase in the index differential of that buffer 514 that results from any other buffers 514 that precede that buffer 514 in the list. A relative offset is not the sole factor that may contribute to the index differential of a buffer 514 entered in a list of abstracted buffers 514. For instance, the initial read position of a buffer 514 when that buffer 514 is entered into a list of abstracted buffers 514 may also impact an index differential of that buffer 514. As an example, consider a buffer 514 that is entered into a list of abstracted buffers 514, and assume that there are other buffers 514 that precede the newly added buffer 514 in the list. If the buffer 514 is partially read when the buffer 514 is entered into the list of abstracted buffers 514 in this example, the buffers reader 526 may exclude the read elements of that buffer 514 from a continuous sequence of elements that is presented by the buffers reader 526. Elements excluded from the continuous sequence of elements by the buffers reader 526 in this example are not indexed by the buffers reader 526. As a result, the index differential of that buffer 514 may be altered by an amount corresponding to the read position of the buffer 514 when that buffer 514 is entered into the list of abstracted buffers 514 in this example (i.e., the initial read position of that buffer 514).

In an embodiment, a buffers reader 526 maintains variable(s) that track characteristics of (a) the buffers reader 526, (b) any buffers 514 abstracted by the buffers reader 526, and/or (c) elements included in a continuous sequence of elements presented by the buffers reader 526. Example variables that may be maintained by a buffers reader 526 include (a) a start position, (b) a read position, (c) a limit, (d) a current pointer, (e) a current offset, (f) a next index, (g) a read and released counter, (h) a capacity, and (i) others. The start position of a buffers reader 526 is the global position of the first element in a continuous sequence of elements that is accessible through the buffers reader 526. A buffers reader 526 may deny a request that attempts to retrieve an element residing before the buffers reader's 526 start position. The read position of a buffers reader 526 indicates the global position of an element in a continuous sequence of elements presented by the buffers reader 526. In particular, the read position of a buffers reader 526 indicates the global position of the element that should be read next. The limit of a buffers reader 526 is the global position of the first element that is inaccessible through the buffers reader 526. For example, if the limit of a buffers reader 526 is twenty, the last element that should be accessible through the buffers reader 526 resides at global position nineteen. The current pointer of a buffers reader 526 may hold a reference to a buffer 514 in a list of abstracted buffers 514 maintained by the buffers reader 526. A buffer 514 that is referenced by the current pointer of a buffers reader 526 is referred to herein as a “current buffer” 514. If a current pointer of a buffers reader 526 is not set to null, the current pointer will typically reference the buffer 514 that represents the element residing at the read position of the buffers reader 526. In other words, the current buffer 514 of a buffers reader 526 is typically the buffer 514 that is currently being read through the buffers reader 526. The current offset of a buffers reader 526 is the relative offset of the buffers reader's 526 current buffer 514. The current offset of a buffers reader 526 may change whenever the current buffer 514 of the buffers reader 526 changes. If the current pointer of a buffers reader 526 is not set to null (i.e., there is a current buffer 514), the next index of the buffers reader 526 indicates the entry in a list of abstracted buffers 514 that immediately follows the current buffer's 514 entry in the list. The read and released counter of a buffers reader 526 measures the number of elements that have been read through the buffers reader 526 and released from the continuous sequence of elements presented by the buffers reader 526. The capacity of the buffers reader 526 is the number of elements presently included in a continuous sequence of elements presented by the buffers reader 526. In an example, variable(s) of a buffers reader 526 are larger than comparable variable(s) that are maintained by a buffer 514. For instance, the read position and limit of an example buffers reader 526 may be longs, whereas the read position and limit of an example buffer 514 may be integers.

In an embodiment, a buffers reader 526 offers method(s) for retrieving and/or altering variables that are maintained by the buffers reader 526. For example, a buffers reader 526 may offer methods that return or alter (a) a start position of the buffers reader 526, (b) a read position of the buffers reader 526, (c) a limit of the buffers reader 526, (d) a current offset of the buffers reader 526, (e) a current pointer of the buffers reader 526, (f) a next index of the buffers reader 526, (g) a read and released counter, and/or (h) other information. In general, a method that alters a variable of a buffers reader 526 may also alter a method of a buffer 514 that is abstracted by the buffers reader 526. For example, a change to the read position of a buffers reader 526 may be accompanied by a corresponding change to the read position of buffer(s) 514 that are abstracted by the buffers reader 526. A method of a buffers reader 526 may alter a variable of a buffer 514 by invoking a method offered by the buffer 514.

In an embodiment, a buffers reader 526 offers methods for adding a buffer 514 to the buffers reader 526. Once a buffer 514 is added to a buffers reader 526, that buffers reader 526 acts as an abstraction of that buffer 514. An example buffers reader 526 offers an “add” method that is configured to (a) accept a buffer 514 as an input parameter and (b) enter that buffer 514 into a list of abstracted buffers 514 maintained by the buffers reader 526. The example buffers reader 526 also offers an “add all” method that is configured to (a) accept a list of buffers 514 as an input parameter and (b) enter the buffers 514 in the list of buffers 514 into a list of abstracted buffers 514 maintained by the buffers reader 526.

In an embodiment, a buffers reader 526 offers method(s) for reading element(s). As used herein, the phrase “reading through a buffers reader” 526 refers to retrieving elements(s) that are included in a continuous sequence of elements presented by the buffers reader 526 and recording those element(s) as being read. An example buffers reader 526 offers a relative “get” method that is configured for reading through the buffers reader 526. If invoked, the relative get method is configured to (a) return the element residing at the read position of the example buffers reader 526 and (b) increment the read position of the example buffers reader 526 by one element. For instance, if the example buffers reader 526 aggregates byte buffers 514, the relative get method is configured to (a) return the byte residing at the read position of the example buffers reader 526 and (b) increment the read position of the example buffers reader 526 by one byte.

In an embodiment, a buffers reader 526 offers method(s) for peeking elements. As used herein, the phrase “peeking through a buffers reader” 526 refers to retrieving element(s) from a continuous sequence of elements presented by the buffers reader 526 without marking those element(s) as read. An example buffers reader 526 offers an absolute “get” method that can be used to peek an element residing at a global position that is specified as an input parameter. The absolute get method does not alter the read position of the example buffers reader 526. Recall that a buffers reader 526 may offer a method for altering the read position of the buffers reader 526. If appropriate, a component of the system can mark an element as read after peeking that element through a buffers reader 526 by altering the buffers reader's 526 read position.

In an embodiment, a buffers reader 526 offers method(s) for releasing elements from a continuous sequence of elements presented by the buffers reader 526. An example buffers reader 526 provides a “release” method that is configured to (a) release any read elements from a continuous sequence of elements, (b) reset the read position of the example buffers reader 526 to zero, and (c) set the limit of the example buffers reader 526 to the remaining number of elements in the continuous sequence of elements. The example buffers reader 526 also offers a “clear” method that is configured to release all elements included in the continuous sequence of elements presented by the example buffers reader 526.

In an embodiment, a buffers reader 526 offers method(s) for (a) reading element(s) included in a continuous sequence of elements presented by the buffers reader 526 and (b) releasing the element(s) that are read. An example buffers reader 526 offers a “get and release” method. The get and release method accepts a number of elements as an input parameter, and the get and release method is configured to (a) return that number elements starting with the element residing at the read position of the example buffers reader 526, (b) release those elements that are returned, (c) set the read position of the buffers reader 526 to zero, and (d) update the limit of the buffers reader 526 to reflect the remaining number of elements included in a continuous sequence of elements presented by the example buffers reader 526.

In an embodiment, a buffers reader 526 offers method(s) for determining the status of information presented by the buffers reader 526. For instance, among other methods, an example buffers reader 526 offers a “has remaining” method, a “remaining” method, and an “is empty” method. The has remaining method is a Boolean method that returns true if a sequence of elements presented by the example buffers reader 526 includes at least one unread element. The remaining method of the example buffers reader 526 is an integer method that returns the number of unread elements included within a continuous sequence of elements presented by the example buffers reader 526. The is empty method of the example buffers reader 526 is a Boolean method that returns true if the buffers reader 526 is not presently acting as an abstraction for any buffer 514.

In an embodiment, a buffers reader 526 offers method(s) for writing to element(s) included in a continuous sequence of elements presented by the buffers reader 526. An example buffers reader 526 provides a relative “put” method. The relative put method accepts an element as an input parameter, and the relative put method is configured to (a) write the element at the read position of the example buffers reader 526 and (b) increment the read position of the example buffers reader 526. The example buffers reader 526 also offers an absolute “put” method. The absolute put method of the example buffers reader 526 accepts a global position and an element as input parameters, and the absolute put method is configured to write the element to the global position.

In an embodiment, a buffers reader 526 offers a getter method for retrieving the read position of the buffers reader 526, and the buffers reader 526 offers a setter method for moving the read position of the buffers reader 526. An example buffers reader 526 offers a “position” method that is configured to return the read position of the example buffers reader 526, and the example buffers reader 526 offers another “position” method that is configured to move the read position of example buffers reader 526 to a relative position that is specified as an input parameter.

In an embodiment, a buffers reader 526 offers a getter method for retrieving the limit of the buffers reader 526, and the buffers reader offers a setter method for altering the limit of the buffers reader 526. An example buffers reader 526 offers a “limit” method that returns the limit of the example buffers reader 526, and the example buffers reader 526 offers another “limit” method that is configured to move the limit of the example buffers reader 526 to a relative position that is specified as an input parameter.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Parsing Stream Data

FIG. 6 illustrates an example set of operations for parsing stream data in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, a stream reader obtains incoming frames, and the stream reader transmits the incoming frames to a stream organizer (Operation 602). The incoming frames embed outgoing frames. More specifically, at least some of the incoming frames are frames that carry higher-level protocol binary payloads, and at least some of these payloads encode outgoing frames. The payload of an incoming frame may encode a portion of an outgoing frame, an entire outgoing frame, and/or multiple outgoing frames. If an incoming frame carries a payload, the payload may be stored to a buffer of the system. The incoming frames also include frame metadata (e.g., frame types, stream IDs, frame offsets, frame lengths, etc.) that the system uses to parse the incoming frames. The incoming frames are delivered to the system through a network connection. Stream data transported through a network connection may get lost, may be partially retransmitted, and/or may be duplicated. Accordingly, the stream reader may obtain the incoming frames in an incorrect order, and the incoming frames obtained by the stream reader may include overlapping frames and duplicate frames. The stream reader transmits the incoming frames to the stream organizer in a sequence and condition that is congruent to the sequence and condition that the incoming frames are obtained by the stream reader. Accordingly, the incoming frames may be transmitted to the frames organizer out of order, and the incoming frames transmitted to the stream organizer may include overlapping frames and duplicate frames. The stream reader relies on the stream organizer to transmit the incoming frames back to the stream reader in an ordered flow of incoming frames that includes neither duplicate frames nor overlapping frames. In an example, the stream reader provides a process incoming frame method, and the stream organizer provides a receive method. In this example, the stream reader obtains an incoming frame as a result of a remote peer calling the process incoming frame method on the stream reader while specifying the incoming frame as an input parameter. While performing the process incoming frame method in this example, the stream reader, in turn, transmits the incoming frame to the stream organizer by calling the receive method on the stream organizer while specifying the incoming frame as an input parameter. Typically, in this example, the receive method of the stream organizer will return an incoming frame that is ready for further processing, or the receive method will return null. If the receive method returns an incoming frame in this example, that incoming frame is the same incoming frame that was specified as an input parameter while invoking the receive method, or that incoming frame is a different incoming frame. In addition to the receive method, the stream reader of this example can request incoming frames from the stream organizer by calling a poll method that is provided by the stream organizer.

Recall that a protocol (e.g., the QUIC Protocol) may permit multiple streams to be established over a single network connection. Accordingly, in an embodiment, any given incoming frame that is received by the system could belong to any one of multiple streams that are established over a single network connection. If multiple streams are established over a network connection, the system may rely on multiple stream readers, stream organizers, read loops, frames decoders, and buffers readers for parsing the multiple streams. In an example, at least one dedicated stream reader, stream organizer, read loop, frames decoder, and buffers reader is created for each stream. However, in other examples, component(s) of the system are configured to parse stream data associated with multiple streams. For instance, in another example, a stream reader is configured to receive incoming frames belonging to multiple streams. The system is configured to dispatch any given incoming frame to the appropriate stream reader based on a stream ID and/or other frame metadata that is included in the incoming frame. If no presently existing stream reader is responsible for parsing the incoming frames associated with a stream, the system may create a new stream reader for that stream, and the system may create other components (e.g., a stream organizer, a read loop, a frames decoder, a buffers reader, etc.) for that stream as needed.

Multiple protocols may influence how the incoming frames are transmitted to the system. For instance, in an embodiment, the incoming frames are associated with at least one lower-layer protocol (e.g., a transport-layer protocol), and the outgoing frames are associated with at least one higher-layer protocol (e.g., an application-layer protocol). Depending on the protocols in play, the outgoing frames may have been arbitrarily split and segmented before being encoded into the payloads of the incoming frames that are delivered to the system through the network connection. The lower-layer frames are delivered to the system packaged within lower-layer packets. A lower-layer packet may include a portion of a lower-layer frame, the entirety of a lower-layer frame, and/or multiple lower-layer frames. If a lower-layer packet includes multiple lower-layer frames (i.e., in whole or in part), the multiple lower-layer frames may belong to the same stream, or the multiple lower-layer frames may belong to different streams. The payloads of the lower-layer frames include the higher-layer frames. A payload of a lower-layer frame may include a portion of a higher-layer frame, the entirety of a higher-layer frame, and/or multiple higher-layer frames.

In an embodiment, the stream organizer organizes the incoming frames, and the stream organizer transmits the incoming frames back to the stream reader in an ordered flow (Operation 604). The stream organizer organizes the incoming frames by reordering incoming frames, replacing incoming frames, discarding incoming frames, and/or performing other operations. To organize the incoming frames of a stream, the stream organizer maintains a flow offset for that stream, and the stream organizer maintains an ordered queue of frames that cannot yet be transmitted back to the stream reader. The flow offset indicates a specific position (e.g., an address of a byte) within the stream; any stream data preceding the flow offset is included within the payloads of incoming frames that have already been transmitted by the stream organizer back to the stream reader (i.e., released for further processing). Based on the flow offset and frame metadata held by the incoming frames (e.g., frame offsets and frame lengths), the stream organizer identifies unordered incoming frames, overlapping incoming frames, and/or duplicate incoming frames. Recall that the frame offset of an incoming frame indicates the starting position of the incoming frame's payload in a stream, and the frame length of the incoming frame indicates the size of the payload. In general, the stream organizer transmits an incoming frame back to the stream reader if the frame offset of that incoming frame matches the flow offset for that stream. When the stream organizer transmits an incoming frame back to the stream reader, the stream organizer advances the flow offset commensurate to the frame length indicated by that incoming frame. In an example, the stream organizer returns an incoming frame to the stream reader responsive to the stream reader calling a receive method on the stream organizer, and/or the stream organizer returns an incoming frame to the stream reader responsive to the stream reader calling a poll method on the stream organizer.

In an embodiment, the stream organizer adds an incoming frame to an ordered queue of frames maintained by the stream organizer if the incoming frame cannot yet be transmitted back to the stream reader. In particular, an incoming frame is added to an ordered queue if (a) the frame offset of the incoming frame is greater than the flow offset of the corresponding stream, (b) the incoming frame is not a duplicate of another incoming frame that is already in the ordered queue, and (c) the incoming frame does not overlap with another incoming frame that is already in the ordered queue. In an example, the stream organizer organizes the ordered queue according to the frame offsets held by the incoming frames that are constituents of the ordered queue. In this example, an incoming frame with an inferior frame offset appears in the ordered queue before another incoming frame with a greater frame offset. When the stream organizer advances the flow offset, the stream organizer may also check if the advancement of the flow offset has rendered a leading frame in the ordered queue (i.e., an incoming frame listed at the front of the ordered queue) eligible for transmission back to the stream reader. In particular, the stream organizer may check if a newly-advanced flow offset matches the frame offset of the leading frame in the ordered queue.

In an embodiment, if an incoming frame delivers a payload that is partially extraneous, the stream organizer replaces the incoming frame with a new frame having a new payload. The new payload of the new frame (a) includes relevant data delivered by the incoming frame and (b) excludes the extraneous data delivered by the incoming frame. To make better use of the system's available resources, the stream organizer selects an approach for creating the new frame based on the circumstances. For instance, the stream organizer may choose to create the new frame by slicing the incoming frame, to minimize the computational cost of creating the new frame. Alternatively, the stream organizer may choose to create the new frame by partitioning the incoming frame, to reduce the amount of memory space that is occupied by the new frame while the system is processing the new frame. If the stream organizer creates the new frame by slicing the incoming frame, the amount of memory space that is occupied by the new frame includes both (a) the memory space allocated for storing the relevant information delivered by the incoming frame and (b) the memory space allocated for storing the extraneous information delivered by the incoming frame. Accordingly, if the incoming frame is sliced, the system is delayed from reclaiming the memory space allocated for the extraneous information until after the new frame is fully processed. In comparison, if the stream organizer creates the new frame by partitioning the incoming frame, the amount of memory space occupied by the new frame does not include the memory space allocated for the extraneous information. Accordingly, if the incoming frame is partitioned, the system is typically allowed to reclaim the memory space allocated for the extraneous information shortly after the new frame is created.

In an embodiment, the stream organizer eliminates an overlap between incoming frames by generating a new frame to replace an incoming frame that overlaps with another incoming frame. As an example, consider an incoming frame that overlaps with another incoming frame. In particular, the payload of the incoming frame overlaps with the payload of the other incoming frame in this example. For the purposes of this example, assume that the other incoming frame has already been transmitted back to the stream reader or is currently residing in the ordered queue. Accordingly, the stream organizer generates a new frame to replace the incoming frame in this example. The stream organizer of this example determines a frame offset, a frame length, and other attributes of the new frame. The frame offset and frame length of the new frame reflect the position and size of the non-overlapping portion of the incoming frame's payload in this example. The frame offset of the new frame is the same as the frame offset of the incoming frame (e.g., if a trailing portion of the original payload overlaps with the other payload), or the frame offset of the new frame is different than the frame offset of the incoming frame (e.g., if a leading portion of the original payload overlaps with the other payload). Furthermore, the stream organizer of this example invokes a method on the buffer that represents the payload of the incoming frame (e.g., a slice method, an allocate method, etc.), and the other method provides instructions for creating a new buffer to represent the non-overlapping portion of the incoming frame's payload. After generating the new frame and the new buffer, the new frame is either promptly returned to the stream organizer or added to the ordered queue depending on the frame offset of the new frame relative to the current flow offset. The original incoming frame is subsequently discarded.

In an embodiment, the stream reader receives the incoming frames transmitted from the stream organizer, and the stream reader presents the payloads of the incoming frames to a read loop in a queue of buffers (Operation 606). The buffers in the queue of buffers store the payloads of the incoming frames. The stream reader adds a buffer to the queue of buffers when a corresponding incoming frame is transmitted back to the stream reader by the stream organizer. Buffers are presented within the queue of buffers according to the sequence that the corresponding incoming frames are transmitted back to the stream reader by the stream organizer. Recall that the stream organizer transmits the incoming frames back to the stream reader in an ordered flow. Therefore, the order of the buffers in the queue of buffers accords to the correct sequence that the payloads stored to the buffers are intended for delivery within the stream. In an example, the payloads of the incoming frames carry binary stream data, and the buffers storing the payloads are byte buffers. In this example, the stream reader is effectively translating the ordered flow of frames returned by the stream organizer into an ordered flow of bytes that is presented by the queue of byte buffers. If the queue of buffers accumulates a sufficient number of buffers for consumption by the read loop, the stream reader may trigger the consumption of the buffers by the read loop. In an example, the stream reader triggers the read loop by invoking a read loop method on the read loop. If the queue of buffers includes an insufficient number of buffers for consumption by the read loop, the stream reader may continue to transmit incoming frames to the stream organizer, and/or the stream reader may poll the stream organizer for additional incoming frames.

In an embodiment, the read loop retrieves the buffers that are presented in the queue of buffers maintained by the stream reader, and the read loop transmits the buffers to a frames decoder (Operation 608). Recall that the buffers store payloads of incoming frames, and the payloads of the incoming frames encode outgoing frames. The read loop relies on the frames decoder to decode the stream data that is carried by these payloads. In other words, the read loop is relying on the frames decoder to extract the outgoing frames from the payloads of the incoming frames represented by the buffers. The read loop transmits the buffers to the frames decoder in the sequence that the buffers are presented in the queue of buffers. Further recall that the queue of buffers is ordered in a correct sequence that the payloads stored to the buffers are intended for delivery within the stream. In an example, the read loop provides a read loop method, and the read loop method is called on the read loop (e.g., the runtime object that is the read loop). In response, the read loop of this example begins to consume the buffers presented in the queue of buffers maintained by the stream reader. In this example, while the read loop method is executing, the read loop obtains a buffer from the queue of buffers as a result of the read loop invoking a poll method on the stream reader. Upon obtaining a buffer from the queue of buffers in this example, the read loop passes the buffer to the frames decoder by calling a submit method on the frames decoder while specifying the buffer as a parameter of the request.

In an embodiment, the frames decoder receives buffers transmitted from the read loop, and the frames decoder adds the buffers to a buffers reader (Operation 610). The buffers reader is a list buffers reader that is capable of wrapping multiple buffers. Recall that, depending on the protocols that governed the transmission of the incoming frames to the system, the outgoing frames may have been indiscriminately split and segmented before being encoded into the incoming frames. While the frames decoder will receive the buffers in an order that corresponds to the correct sequence of stream data within the stream, generating an outgoing frame by way of interacting with individual buffers may nonetheless be a non-trivial task to the extent that the outgoing frame is arbitrarily divided amongst multiple buffers. To avoid the computational complexity that would be incurred while attempting to reconstruct an outgoing frame that has been dispersed across multiple buffers, the frames decoder relies on the buffers reader to serve as an abstraction of the multiple buffers. The buffers reader maintains a list of abstracted buffers, and the buffers reader presents a continuous sequence of elements. If a buffer is entered into the list of abstracted elements, elements represented by that buffer may be included in the continuous sequence of elements that is presented by the buffers reader. In an example, the buffers reader provides an add method, and the frames decoder transmits a buffer to the buffers reader by calling the add method on the buffers reader while specifying the buffer as a parameter of the request.

In an embodiment, the frames decoder extracts outgoing frames from the payloads of the incoming frames that are aggregated by the buffers reader, and the frames decoder transmits the outgoing frames to the read loop (Operation 612). In an example, the frames decoder decodes stream data encoded into the continuous sequence of elements presented by the buffers reader by calling a decode method of an outgoing frame reference type while specifying the buffers reader as a parameter of the request. In this example, the decode method is a static method of an outgoing frame reference type. By presenting the elements represented by the individual buffers as a continuous sequence of elements, the buffers reader allows the decode method of this example to read stream data that is split across multiple buffers as if the stream data were instead represented by a single buffer. Typically, in this example, the decode method returns an outgoing frame that is decoded from the continuous sequence of elements, or the static decode method returns null. If the static decode method returns an outgoing frame in this example, the outgoing frame is (a) a complete frame, (b) a partial frame, (c) an unknown partial frame, (d) a malformed frame, or (e) another variety of an outgoing frame.

In an embodiment, the read loop delivers the outgoing frames to a stream recipient (Operation 614). An outgoing frame delivered to the stream recipient is a complete frame, a partial frame, a malformed frame, or another variety of outgoing frame. Returning a partial frame to the stream recipient rather than a complete frame may allow the read loop to begin delivery of the partial frame's payload to the stream recipient prior to the entirety of the partial frame being decoded. The ability to begin delivery of a frame's payload prior to the entirety of that payload being decoded may reduce the amount of buffer memory that is consumed by the system and reduce the overall latency of stream data delivery. An outgoing frame may be delivered to a stream recipient as a runtime object related to an outgoing frame reference type, as stream data formatted according to a protocol associated with that outgoing frame, and/or in any another medium.

### 5. Data Aggregation Techniques

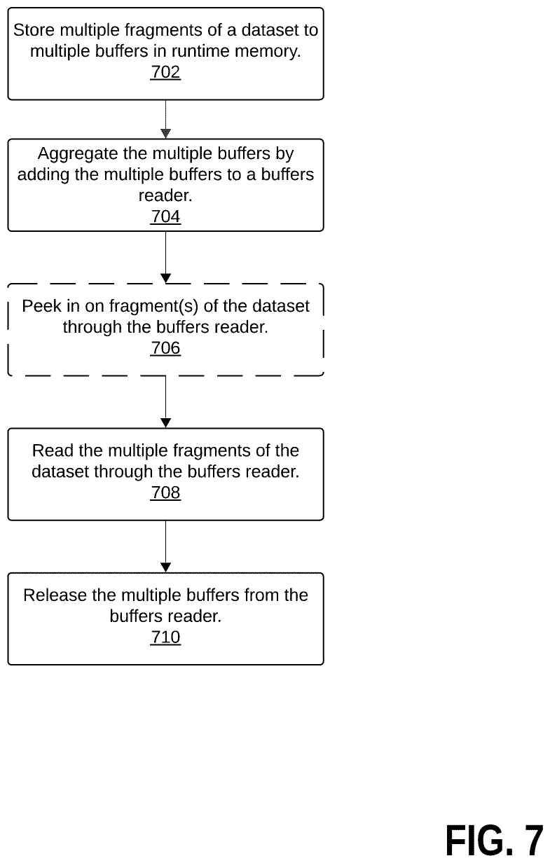

FIG. 7 illustrates an example set of operations for parsing a dataset that has been fragmented into multiple parts in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system stores multiple fragments of a dataset to multiple buffers in runtime memory (Operation 702). A fragment of the dataset is stored, more specifically, to an underlying data structure (e.g., an array) that backs a buffer of the multiple buffers, and the buffer serves as a representation of that fragment of the dataset in runtime memory. A buffer representing a fragment of the dataset can subsequently be used by the system to manipulate elements of that fragment of the dataset. However, the dataset may have been fragmented arbitrarily. Consequently, attempting to process the dataset by manipulating the multiple fragments individually through the multiple buffers may significantly complicate reassembling and processing the dataset. As discussed below, the system avoids this issue by using a buffers reader to aggregate the multiple fragments of the dataset. In an example, the dataset is multiple outgoing frames that have been delivered to the system encoded within multiple payloads of multiple incoming frames, and the multiple payloads are stored to the multiple buffers. In this example, a higher-layer frame may be arbitrarily divided between buffers if that higher-layer frame is delivered to the system encoded within the payloads of two or more incoming frames.

In an embodiment, the system aggregates the multiple buffers by adding the multiple buffers to a buffers reader (Operation 704). The system adds the multiple buffers to a preexisting buffers reader, or the system instantiates a new buffers reader for the multiple fragments. In either scenario, the buffers reader is a list buffers reader that maintains a list of abstracted buffers. When a buffer is added to the buffers reader, an entry is created for that buffer in the list of abstracted buffers. An example entry in the list of abstracted buffers includes (a) a reference to a buffer, (b) an initial read position of the buffer, (c) a limit of the buffer, and/or (d) other information. As discussed in further detail below, the information included in the entry is used by the system to process the buffer. To add the multiple buffers to the list of abstracted buffers, the system may execute method(s) offered by the buffers reader. For example, the system may add the multiple buffers to the buffers reader by repeatedly executing an add method on the buffers reader. An example set of operations for adding a buffer to a buffers reader is described below in Subsection 5.1 titled “Aggregating Data.” Recall that a buffers reader may provide multiple methods that can be used to add buffers to the buffers reader. In another example, the system adds a list of buffers to the buffers reader by executing an add all method on the buffers reader. In yet another example, the multiple buffers are added to a buffers reader as the buffers reader is being instantiated by the system.

In an embodiment, the system may peek on fragment(s) of the dataset through the buffers reader (Operation 706). Recall that “peeking through a buffers reader” refers to retrieving element(s) of buffer(s) aggregated through the buffers reader without marking those element(s) as read. Whether or not the system peeks through the buffers reader may vary depending on the circumstances of the present application. In an example, the fragmented dataset includes a higher-layer frame, and the system peeks through the buffers reader to discern if the higher-layer frame possesses a valid header. To peek through the buffers reader, the system may execute method(s) provided by the buffers reader. For example, the system may peek through the buffers reader by executing an absolute get method that is offered by the buffers reader. An example set of operations for peeking through a buffers reader is described below in Subsection 5.2 titled “Peeking Aggregated Data.” A buffers reader may offer multiple methods for peeking through the buffers reader. It should also be noted that the buffers reader may offer method(s) for moving the read position of the buffers reader without retrieving elements. If appropriate, the system may execute a method for altering the read position of the buffers reader after peeking through the buffers reader.

In an embodiment, the system reads the multiple fragments of the dataset through the buffers reader (Operation 708). The buffers reader presents the multiple fragments of the dataset as a continuous sequence of elements. The elements in the continuous sequence of elements are consecutively indexed by the buffers reader, and the buffers reader maintains a read position that indicates what element in the continuous sequence should be read next. Recall that “reading through a buffers reader” refers to retrieving elements(s) that are included in a continuous sequence of elements presented by the buffers reader and recording those element(s) as being read. To read through the buffers reader, the system may execute method(s) offered by the buffers reader. For example, the system may read elements of the dataset through the buffers reader by repeatedly executing a relative get method on the buffers reader. An example set of operations for reading an element through a buffers reader is described below in Subsection 5.3 titled “Reading Aggregated Data.” Recall that a buffers reader may offer multiple methods for reading through the buffers reader. For instance, in another example, the system reads the multiple fragments through the buffers reader by executing a get and release method on the buffers reader.

In an embodiment, the system releases the multiple fragments of the dataset from the buffers reader (Operation 710). In general, the system releases a fragment from the buffers reader after that fragment is read. A fragment of the dataset may be partially read, and the system may release part of that fragment by releasing the read elements of that fragment while retaining the unread elements of that fragment. To release read and/or unread elements of the dataset from the buffers reader, the system may execute method(s) offered by the buffers reader. For example, the system may release read elements from the buffers reader by executing a release method on the buffers reader. An example set of operations for releasing read elements from a buffers reader is described below in Subsection 5.4 titled “Releasing Aggregated Data.” Recall that a buffers reader may offer multiple methods that can be used to release aggregated elements. For instance, in another example, the system reads and releases elements of the dataset from the buffers reader by executing a get and release method on the buffers reader. In this other example, the get and release method combines Operation 706 and Operation 708. In yet another example, the system releases elements of the dataset (read and/or unread) by executing a clear method on the buffers reader.

### 5.1 Aggregating Data

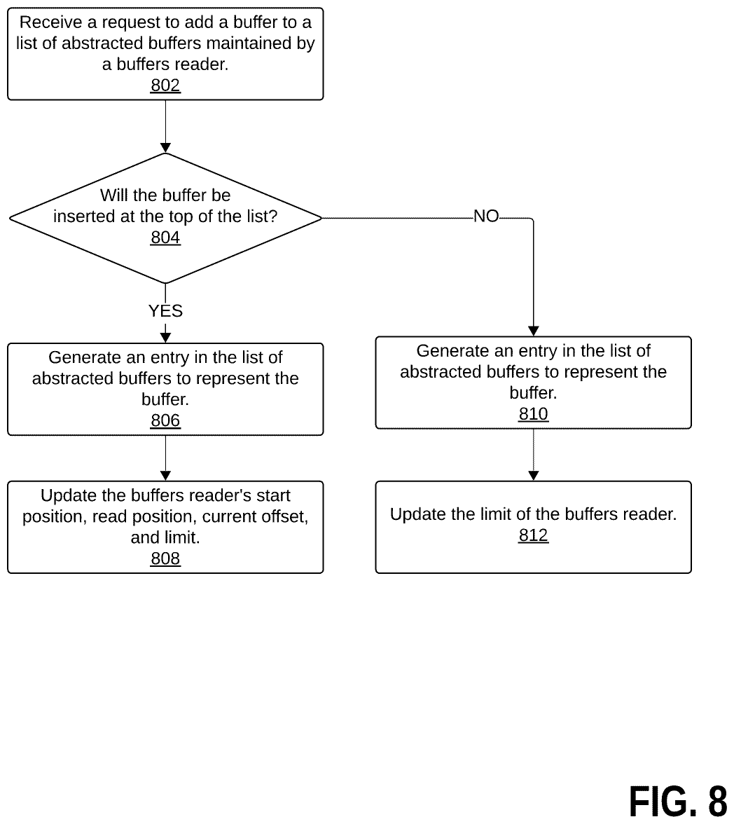

FIG. 8 illustrates an example set of operations for aggregating data in accordance with one or more embodiments. One or more operations illustrated in FIG. 8 may be modified, rearranged, or omitted. Accordingly, the particular sequence of operations illustrated in FIG. 8 should not be construed as limiting the scope of one or more embodiments.

In an embodiment, the system receives a request to add a buffer to a buffers reader (Operation 802). More specifically, the request (hereafter the “add request”) directs the system to create an entry for the buffer in a list of abstracted buffers maintained by the buffers reader. The buffers reader offers an add method, and the add request is an invocation of the add method on the buffers reader. The invocation of the add request on the buffers reader specifies the buffer (hereafter the “input buffer”) as an input parameter. It should be noted that the input buffer may be a new buffer that was created by slicing or partitioning an original buffer. Additionally, or alternatively, it may be that the input buffer has already been partially read. In an example, the add request originates from another component of the system. For instance, in this example, the system may execute the add method while the system is executing a submit method of a frames decoders that invokes the add method. In this example, the buffers entered in the list of abstracted buffers have been preprocessed by other components of the system (e.g., a stream reader, a stream organizer, a read loop, the frames decoder, etc.). As a result of the preprocessing, the buffers are entered into the list of abstracted buffers in the correct order that the buffers should be read through the buffers reader.

In an embodiment, the system determines if the input buffer will be entered at the beginning of the list of abstracted buffers, and the system proceeds to another operation based on the determination (Operation 804). If the input buffer will be entered at the beginning of the list of abstracted buffers (YES at Operation 804), the system proceeds to Operation 806. Alternatively, if the input buffer will not be entered as the leading buffer in the list of abstracted buffers (NO at Operation 804), the system proceeds to Operation 810. In an example, the list of abstracted buffers is ordered according to the sequence that buffers are added to the buffers reader. Therefore, the system of this example can conclude that the input buffer will be entered at the beginning of the list of abstracted buffers if the list is presently empty. On the other hand, the system of this example can conclude that the input buffer will not be entered at the beginning of the list of abstracted buffer if there is at least one other buffer already entered in the list. In another example, the system may not be able to determine if the input buffer will be entered at the beginning of the list of abstracted buffers based solely on whether or not the list is empty. For instance, in this other example, if there are other buffer(s) already entered in the list of abstracted buffers, the system may need to compare the input buffer to the other buffer(s) to discern if the input buffer should be entered before or after the other buffer(s).

In an embodiment, the system generates a new entry for the input buffer in the list of abstracted buffers (Operation 806). The new entry in the list of abstracted may include (a) a reference to the input buffer, (b) an initial read position of the input buffer, (c) a limit of the input buffer, and/or (d) other information. In this scenario, the system is entering the input buffer at the beginning of the list of abstracted buffers, and the new entry in the list of abstracted buffers indicates that the initial read position of the input buffer is the relative position of the first element that is accessible through the buffer. As an example, assume that the input buffer indexes elements starting from zero, and further assume that the read position of the input buffer is three when the system is entering the input buffer into the list of abstracted buffers. Even though the true initial read position of the input buffer is three in this example, the new entry in the list of abstracted buffers indicates that the initial read position of the input buffer is zero. However, the system of this example will also set the start position of the buffers reader to three, and the system will set the read position of the buffers reader to three (i.e., Operation 808). As a result, the buffers reader of this example will not permit an attempt to retrieve an element that resides prior to the start position of the buffers reader (i.e., the true initial read position of the input buffer), and the buffers reader will not permit an attempt to move the read position of the buffers reader to a global position before the start position of the buffers reader (i.e., a global position prior to three).

In an embodiment, the system updates variables of the buffers reader to reflect the input buffer being entered as the leading buffer in the list of abstracted buffers (Operation 808). In particular, the system updates the (a) start position of the buffers reader, (b) read position of the buffers reader, (c) current offset of the buffers reader, (d) limit of the buffers reader, and/or (e) other variables of the buffers reader. The system updates the start position of buffers reader to match the true read position of the input buffer at the time the input buffer is entered into the list of abstracted buffers, and the system updates the read position of the buffers reader to match the buffers reader's new start position. Therefore, the read position of the buffers reader will also match the true read position of the input buffer at the time the input buffer is entered into the list of abstracted buffers. The system sets the current offset of the buffers reader to zero. Recall that (a) the current offset of the buffers reader is the relative offset of the current buffer, and (b) a relative offset measures any contribution to a buffer's index differential that results from any other buffers that precede that buffer in a list of abstracted buffers. The input buffer will likely be the next current buffer of the buffers reader because the input buffer is the leading buffer in the list of abstracted buffers in this scenario. The system sets the limit of the buffers reader to a value that equals the new start position of the buffers reader plus the remaining number of unread elements represented by the input buffer. In general, the buffers reader will not permit a request that attempts to access an element at a global position that meets or exceeds the buffers reader's limit at the time of the request. Since the input buffer is the leading buffer in this scenario, the new limit of the buffers reader will typically be equal to the limit of the input buffer. It should be noted that, following these updates, the state of the buffers reader mimics the state of the input buffer when the input buffer is entered into the list of abstracted buffers. In the instant that follows these updates, the buffers reader will expose the same read position as the input buffer, and the buffers reader will possess the same limit as the input buffer. As a result of the buffers reader mimicking the state of the input buffer, the buffers reader may be used interchangeably with the input buffer even if the input buffer has been partially read prior to the system entering the input buffer into the list of abstracted buffers. At the same time, as long as the start position of the buffers reader remains constant, the buffers reader will not permit a request that attempts to access an element residing before the true initial read position of the input buffer, because the buffers reader will not permit a request to access an element that resides at a global position that is before the start position of the buffers reader in this scenario. Furthermore, the buffers reader will not permit an attempt to move the read position of the buffers reader to a global position that is before the start position of the buffers reader. In this way, buffers reader prevents issues that might otherwise arise as a result of elements represented by the input buffer being reprocessed after the input buffer has been added to the list of abstracted buffers. In an example, the system invokes methods on the input buffer while entering the buffer in the list of abstracted buffers. For instance, to determine the read position of the input buffer at the time the input buffer is entered into the list of abstracted buffers, the system may execute a position method provided by the input buffer in this example. Similarly, the system may determine the remaining number of unread elements represented by the input buffer by executing a remaining method offered by the input buffer in this example. The remaining number of unread elements represented by the input buffer is equal to the limit of the input buffer minus the read position of the input buffer.

In an embodiment, the system generates a new entry for the input buffer in the list of abstracted buffers that records the true initial read position of the input buffer at this time (Operation 810). In addition, the new entry may include a reference to the input buffer, the limit of the input buffer, and/or other information. Recall that in this scenario, the list of abstracted buffers is not empty, and the input buffer will not be entered at the beginning of the list. The system does not present elements represented by the input buffer that are before the true initial read position of the input buffer as recorded in the input buffers entry in the list of abstracted buffers. Therefore, if the initial read position of the input buffer is greater than zero, the buffers reader will exclude at least some of the elements represented by the input buffer from a continuous sequence of elements that is presented by the buffers reader. In an example, the system learns the read position and limit of the input buffer by executing methods (e.g., a position method and a limit method) offered by the input buffer.

In an embodiment, the system updates the limit of the buffers reader (Operation 812). In particular, the limit of the buffers reader is increased by the remaining number of unread element represented by the input buffer at the time the input buffer is entered into the list of abstracted buffers. Since the input buffer is not entered as the leading buffer in this scenario, the remaining number of elements represented by the input buffer is equal to the limit of the input buffer minus the initial read position of the input buffer as recorded by the buffer's entry in the list of abstracted buffers.

### 5.2 Peeking Aggregated Data

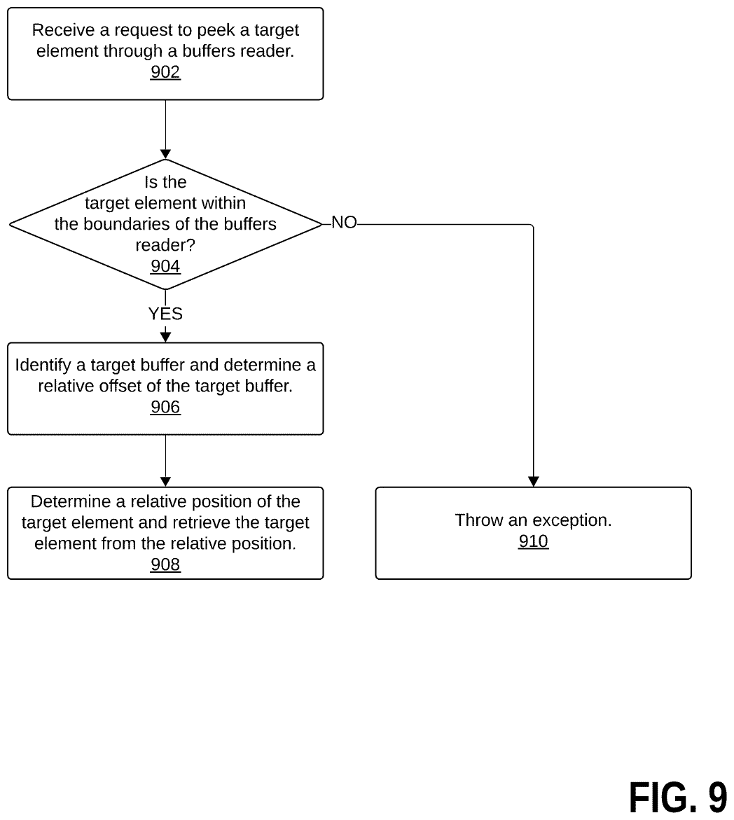

FIG. 9 illustrates an example set of operations for peeking aggregated data in accordance with one or more embodiments. One or more operations illustrated in FIG. 9 may be modified, rearranged, or omitted. Accordingly, the particular sequence of operations illustrated in FIG. 9 should not be construed as limiting the scope of one or more embodiments.

In an embodiment, the system receives a request to peek on a target element through a buffers reader (Operation 902). The buffers reader offers an absolute get method, and the request (hereafter the “peek request”) is an invocation of the absolute get method on the buffers reader. The invocation of the absolute get method specifies a global position of the target element. Recall that a global position of an element is the location of that element with respect to the indexing of a buffers reader. Hereafter, the global position of the target element that is specified with the peek request is referred to as the “target position.” In an example, the peek request originates from another component of the system. For instance, in this example, the system may execute the absolute get method while the system is executing a decode method of a frames decoder that invokes the absolute get method.

In an embodiment, the system determines if the target element is within the boundaries of the buffers reader, and the system proceeds to another operation based on the determination (Operation 904). In other words, the system is checking if access to the target element is permitted through the buffers reader. To this end, the system cross references the target position against (a) the start position of the buffers reader and (b) the limit of the buffers reader. The target element is within the boundaries of the buffers reader if (a) the target position is equal to or greater than the start position of the buffers reader and (b) the target position is less than the limit of the buffers reader. On the other hand, the target element is typically inaccessible through the buffers reader if (a) the target position is less than the start position of the buffers reader or (b) the target position is equal to or greater than the limit of the buffers reader. If the target element is within the boundaries of the buffers reader (YES at Operation 904), the system proceeds to Operation 906. If the target element is within the boundaries of the buffers reader, the target element may be represented by a buffer (referred to hereafter as the “target buffer”) that is included within a list of abstracted buffers maintained by the buffers reader. Alternatively, if the target element is not within the boundaries of the buffers reader (NO at Operation 904), the system proceeds to Operation 910.

In an embodiment, the system identifies the target buffer, and the system determines a relative offset of the target buffer (Operation 906). The system identifies the target buffer and determines the relative offset of the target buffer based on (a) the target position, (b) the list of abstracted buffers, (c) variables of the buffers reader (e.g., a read position, a current pointer, a current offset, etc.), (d) variables of buffers in the list of abstracted buffers, and/or (e) other information. Recall that (a) an index differential of a buffer represents the difference between the indexing of elements by the buffer and the indexing of those elements by a buffers reader, (b) a relative offset of a buffer measures any contribution to the buffer's index differential that results from any other buffers that precede that buffer in a list of abstracted buffers, and (c) a relative position of an element represented by the buffer is the location of that element with respect to the indexing of the buffer. The target buffer may be any buffer that is entered in the list of abstracted buffers. If the buffers reader has a current buffer, the target buffer is (a) the current buffer, (b) a buffer that precedes the current buffer in the list of abstracted buffers, or (c) a buffer that follows the current buffer in the list of abstracted buffers.

To identify the target buffer, the system, according to an embodiment, compares the target position to the read position of the buffers reader. The read position of the buffers reader will generally identify the global position of an element represented by the current buffer. If there is not a current buffer, the read position of the buffers reader will typically be zero. Therefore, if the target position matches the read position of the buffers reader, the system can generally either conclude that (a) the target buffer is the current buffer, or (b) the target buffer is the leading buffer in the list of abstracted buffers. If the target position does not match the read position of the buffers reader, further analysis may be needed to identify the target buffer.

To roughly gauge where the target buffer is entered within the list of abstracted buffers, the system, according to an embodiment, compares the target position to the current offset. Recall that the current offset is the relative offset of the current buffer (i.e., the buffer that is referenced by the current pointer of the buffers reader). Generally, if the target position is equal to or greater than the current offset, the target buffer is the current buffer, or the target buffer is another buffer that is listed after the current buffer in the list of abstracted buffers maintained by the stream organizer. If the target position is less than the current offset, the target buffer is typically a buffer that is listed before the current buffer in the list of abstracted buffers.

To identify the target buffer and determine the target offset, the system, according to an embodiment, may iterate through one or more entries in the list of abstracted buffers. In an example, the target position is equal to or greater than the current offset, and the system iterates forward through the list of abstracted buffers. In this example, the initial entry in the list of abstracted buffers that the system evaluates while iterating forwards through the list is the entry representing the current buffer. If the system reaches the end of the list of abstracted buffers without identifying the target buffer, the system may throw an exception in this example. In an alternative example, the target position is less than the current offset, and the system iterates backwards through the list of abstracted buffers. In this alternative example, the initial entry in the list of abstracted buffers that is evaluated by the system while iterating backwards through the list is the entry representing the buffer that immediately precedes the current buffer's entry in the list. If the system reaches the beginning of the list of abstracted buffers without identifying the target buffer, the system may throw an exception in this alternative example.

While evaluating an entry in the list of abstracted buffers, the system, according to an embodiment, determines a relative offset for the buffer that corresponds to that entry. Recall that an example entry in the list of abstracted buffers may include (a) a reference to a buffer corresponding to the entry, (b) an initial read position of the buffer (e.g., the true initial read position of the buffer or zero), (c) a limit of the buffer, and/or (d) other information. As a first example, assume that the system is evaluating the entry in the list of abstracted buffers that corresponds to the current buffer of the buffers reader. In this first example, the system assumes that the relative offset of the current buffer is equal to the current offset of the buffers reader. As a second example, assume that the system is evaluating the leading entry in the list of abstracted buffers. In this second example, the system concludes that the relative offset of the buffer corresponding to the leading entry is equal to zero. As a third example, assume that while iterating forwards through the list of abstracted buffers, the system completes evaluation of a preceding entry in the list, and the system begins evaluating a present entry in the list that immediately follows the preceding entry. The system of this third example has already determined the relative offset of the buffer (hereafter the “preceding buffer”) corresponding to the preceding entry. The system of this third example determines the relative offset of the present buffer based on (a) the relative offset of the preceding buffer and (b) the initial read position and limit of the preceding buffer as recorded in the preceding entry. In this third example, the relative offset of the present buffer is equal to the relative offset of the preceding buffer plus the limit of the preceding buffer minus the initial read position of the preceding buffer. As a fourth example, assume that, while iterating backwards through the list of abstracted buffers, the system completes evaluation of a latter entry in the list, and the system begins evaluating a present entry in the list that immediately precedes the latter entry. The system of this fourth example has already determined the relative offset of the buffer (hereafter the “latter buffer”) corresponding to the latter entry. The system of this fourth example determines the relative offset of the present buffer based on (a) the relative offset of the latter buffer and (b) the initial read position and limit of the present buffer as recorded in the present entry. In this fourth example, the relative offset of the present buffer is equal to the relative offset of the latter buffer minus the limit of the present buffer plus the initial read position of the present buffer.

While evaluating an entry in the list of abstracted buffers, the system, according to an embodiment, determines if the buffer corresponding to the entry is the target buffer based on a relative offset that the system has determined for that buffer. In an example, the system, more specifically, determines if a present buffer of a present entry is the target buffer based on (a) the target position, (b) a relative offset of the present buffer, and (c) the initial read position and limit of the present buffer as recorded in the present entry. In this example, the system determines a first differential that is equal to the target position minus the relative offset of the present buffer, and the system determines a second differential that is equal to the limit of the present buffer minus the initial read position of the present buffer. If the first differential is less than the second differential in this example, the system concludes that the present buffer is the target buffer, and therefore, the relative offset of the present buffer is the target offset. Alternatively, if the first differential is equal to or greater than the second differential in this example, the system concludes that the present buffer is not the target buffer, and the system subsequently iterates forwards or backwards to another entry in the list of abstracted buffers.

In an embodiment, the system determines a relative position of the target element, and the system retrieves the target element from that relative position (Operation 908). The relative position of the target element is the location of the target element according to the indexing of the target buffer. The system may determine the relative position of the target element based on (a) the target position, (b) the target offset of the target buffer, (c) an initial read position of the target buffer as recorded in the entry within the list of abstracted buffers corresponding to the target buffer, and/or (d) other information. Recall that the relative position of an element represented by a buffer is equal to the global position of the element minus the index differential of the buffer. In an example configuration of the buffers reader, the index differential of the target buffer is equal to the relative offset of the target buffer minus the initial read position of the target buffer as recorded by the target buffer's entry within the list of abstracted buffers. Thus, in this example, the relative position of the target element is equal to the target position minus the target offset plus the initial read position of the target buffer. The system does not alter the read position of the buffers reader in response to retrieving the element. Upon retrieving the target element, the system may communicate the target element to the source of the peek request and/or other recipient(s). In an example, the system retrieves the target element from the target buffer by executing an absolute get method of the buffers reader. In this example, the absolute get method of the buffer accepts the relative position of the target element as an input parameter, and the absolute get method of the buffer does not alter the read position of the buffer. In other words, the system of this example retrieves the target element by peeking through the target buffer.

In an embodiment, the system throws an exception (Operation 910). In this scenario, the target position is either (a) less than the start position of the buffers reader or (b) equal to or greater than the limit of the buffers reader. Accordingly, the system throws an out of bounds exception because the peek request is attempting to access an element that resides outside the boundaries of the buffers reader.

### 5.3 Reading Aggregated Data

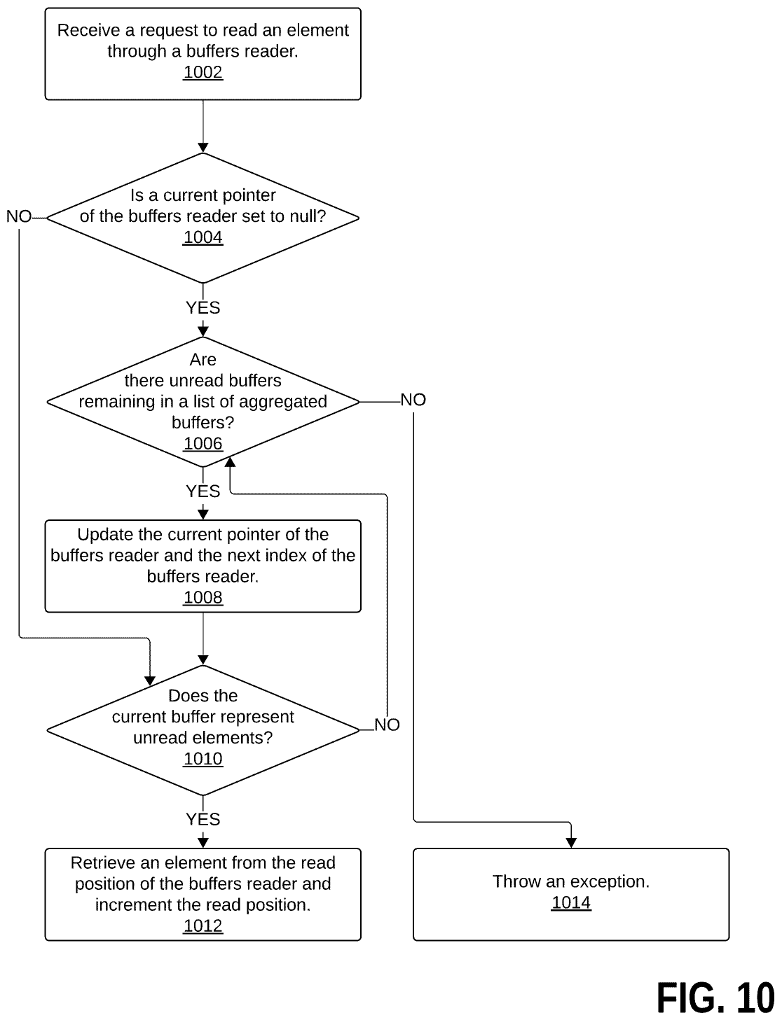

FIG. 10 illustrates an example set of operation for reading aggregated data in accordance with one or more embodiments. One or more operations illustrated in FIG. 10 may be modified, rearranged, or omitted. Accordingly, the particular sequence of operations illustrated in FIG. 10 should not be construed as limiting the scope of one or more embodiments.

In an embodiment, the system receives a request to read an element through a buffers reader (Operation 1002). The buffers reader offers a relative get method, and the request (hereafter the “read request”) is an invocation of the relative get method on the buffers reader. The request need not specify a position as an input parameter. The global position of the element that should be read is the read position of the buffers reader, and the relative position of the element that should be read is the read position of a buffer entered in a list of abstracted buffers maintained by the buffers reader. In an example, the read request originates from another component of the system. For instance, the system may execute the relative get method while the system is executing a decode method of a frames decoder that invokes the relative get method in this example.

In an embodiment, the system determines if a current pointer of the buffers reader is set to null, and the system proceeds to another operation based on the determination (Operation 1004). If the current pointer is set to null (YES at Operation 1004), the system proceeds to Operation 1006. Alternatively, if the current pointer refers to a current buffer (NO at Operation 1004), the system proceeds to Operation 1010. If the current pointer is not set to null, the current pointer will reference a buffer (i.e., the current buffer) that is included in a list of abstracted buffer maintained by the buffers reader.

In an embodiment, the system determines if there are any buffers remaining in the list of abstracted buffers that are at least partially unread, and the system proceeds to another operation based on the determination (Operation 1006). In other words, the system is determining if there are any unread elements remaining in the continuous sequence of elements presented by the buffers reader. If there are any buffers remaining in the list of abstracted buffers that are at least partially unread (YES at Operation 1006), the system proceeds to Operation 1008. Alternatively, if the list of abstracted buffers includes no buffers that are at least partially unread (NO at Operation 1006), the system proceeds to Operation 1014.

To determine if there are any buffers that are at least partially unread remaining in the list of abstracted buffers, the system, according to an embodiment, may cross reference the next index of the buffers reader against the number of entries in the list of abstracted buffers. If the next index indicates a value that is lower than the number of entries in the list of abstracted buffers, then there is at least one buffer in the list of abstracted buffers that represents unread elements. If the value indicated by the next index is greater than or equal to than the number of entries in the list of abstracted buffers, then there are no unread buffers remaining in the list of abstracted buffers.

To determine if there are any buffers that are at least partially unread remaining in the list of abstracted buffer, the system, according to an embodiment, may cross reference the read position of the buffers reader against the limit of the buffers reader. If the read position of the buffers reader matches the limit of the buffers reader, there are no unread elements remaining in the continuous sequence of elements presented by the buffers reader.

In an embodiment, the system updates the current pointer of the buffers reader, and the system updates the next index of the buffers reader (Operation 1008). Recall that in this scenario, the system has determined that there is at least one partially unread buffer in the list of abstracted buffers. The next buffer that is to be read is entered within the list of abstracted buffers at the list index specified by the next index. Accordingly, the current pointer of the buffers reader is updated so that the current pointer refers to the buffer (i.e., the new current buffer) corresponding to the entry indicated by the next index. The system increments the next index by one so that the next index no longer indicates the index of the new current buffer's entry in the list of abstracted buffers.

In an embodiment, the system determines if the current buffer represents any unread elements, and the system proceeds to another operation based on the determination (Operation 1010). In other words, the system is determining whether or not the current buffer is fully read. The current buffer is fully read if the read position of the current buffer matches the limit of the current buffer. If the current buffer represents unread elements (YES at Operation 1010), the system proceeds to Operation 1012. Alternatively, if the current buffer is fully read (NO at Operation 1010), the system returns to Operation 1006. In an example, the system determines if the current buffer represents any unread elements by executing method(s) offered by the current buffer. In other words, the relative get method of the buffers reader may invoke a method of the current buffer to discern if the current buffer represents any unread elements in this example. For instance, the system of this example may execute a has remaining method on the current buffer, and/or the system may execute a remaining method on the current buffer. In this example, the has remaining method is a Boolean method that returns true if the current buffer represents at least one unread element, and the remaining method is an integer method that returns the number of elements, if any, between the read position of the current buffer and the limit of the current buffer (i.e., the number of unread elements).

In an embodiment, the system retrieves an element residing at the read position of the buffers reader, and the system increments the read position of the buffers reader (Operation 1012). The element retrieved from the read position of the buffers reader is communicated to the source of the read request, and/or the element is communicated to another recipient. The system may retrieve the element by reading through the current buffer. In an example, the system retrieves the element from the read position of the buffers reader by executing a relative get method offered by the current buffer. While executing the relative get method of the current buffer, the system of this example increments the read position of the current buffer. Therefore, in this example, the system increments both (a) the read position of the current buffer and (b) the read position of the buffers reader.

In an embodiment, the system throws an exception (Operation 1014). In this scenario, the read request is attempting to read an element residing at a global position that meets or exceeds the limit of the buffers reader. Therefore, the system may throw an under flow exception in this scenario.

### 5.4 Releasing Aggregated Data

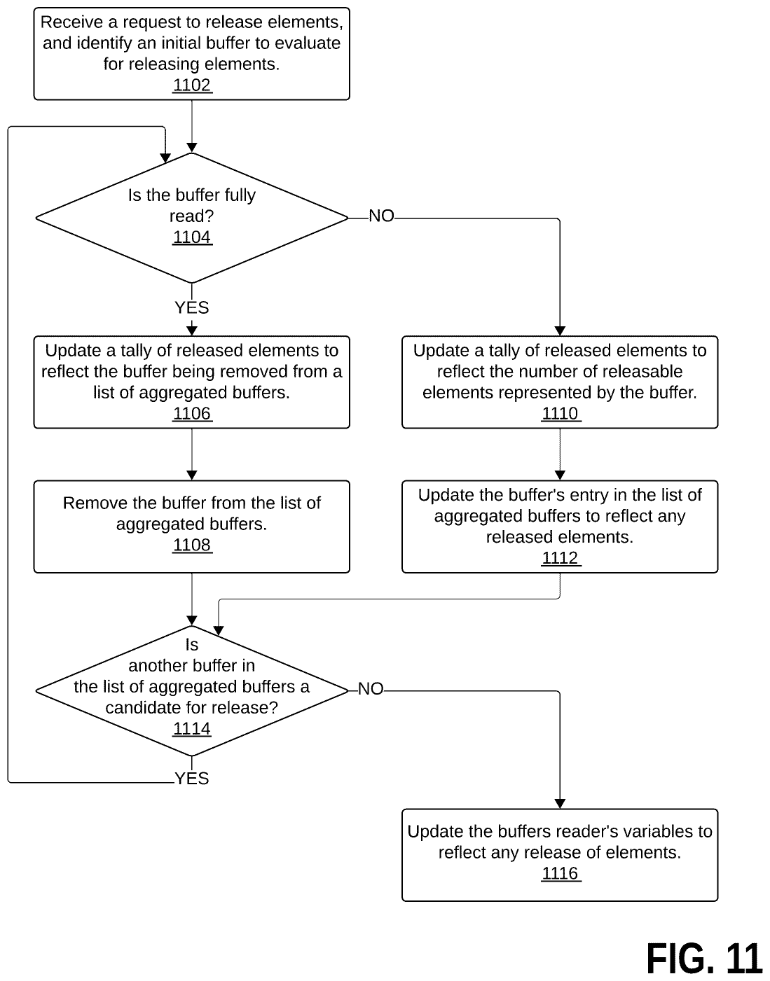

FIG. 11 illustrates an example set of operations for releasing aggregated data in accordance with one or more embodiments. One or more operations illustrated in FIG. 11 may be modified, rearranged, or omitted. Accordingly, the particular sequence of operations illustrated in FIG. 11 should not be construed as limiting the scope of one or more embodiments.

In an embodiment, the system receives a request to release elements from a continuous sequence of elements presented by a buffers reader, and the system identifies a buffer to initially evaluate for releasing elements (Operation 1102). The buffers reader offers a release method, and the request (hereafter the “release request”) is an invocation of the release method on the buffers reader. The buffer identified for initial evaluation is a buffer entered in a list of abstracted buffers maintained by the buffers reader. How the system identifies the buffer to initially evaluate may vary between applications. For instance, the manner that the buffer is identified may vary depending on (a) the sequence that buffers are added to the list of abstracted buffers, (b) the organization of the list, (c) the characteristics of the data that is being aggregated by the buffers reader, (d) if and how the buffers are processed or sorted prior to entry in the list, (e) and/or other circumstances of the present application. In an example, the request originates from another component of the system. For instance, in this example, the system may execute the release method while the system is executing a decode method of a frames decoder that invokes the release method. In this example, the buffer identified by the system for initial evaluation corresponds to the leading entry in the list of abstracted buffers.

In an embodiment, the system determines if the buffer is fully read, and the system proceeds to another operation based on the determination (Operation 1104). Stated differently, the system is determining if the buffer represents any unread elements. If the buffer is fully read (YES at Operation 1104), the system proceeds to Operation 1106. In this scenario, the read position of the buffer matches the limit of the buffer. Alternatively, if the buffer represents at least some unread elements (NO at Operation 1104), the system proceeds to Operation 1110. In this alternative scenario, the buffer is entirely unread, or the buffer is partially read. If the buffer indexes elements starting from zero, the buffer is entirely unread if the read position of the buffer is zero, and the buffer is partially read if the read position of the buffer is (a) greater than zero and (b) less than the limit of the buffer. In an example, the system determines if the buffer is fully read by executing a method offered by the buffer. In other words, the release method of the buffers reader invokes a method of the buffer to discern if the buffer is fully read in this example. For instance, the system of this example may execute a remaining method on the buffer, and/or the system may execute a has remaining method on the buffer. The system of this example may conclude the buffer is fully read because (a) the remaining method returns zero and/or (b) the has remaining returns false. Alternatively, the system of this example may conclude that the buffer is not fully read because (a) the remaining method returns a value greater than zero and/or (b) the has remaining method returns false.

In an embodiment, the system determines a number of releasable elements represented by the buffer, and the system adds the number of releasable elements to a tally of elements that are being released from the continuous sequence of elements (Operation 1106). The release method of the buffers reader deems an element releasable if that element is both (a) read and (b) presently included in the continuous sequence of elements. Recall that the buffer is fully read in this scenario. Therefore, the number of releasable elements represented by the buffer in this scenario is equal to the difference between the limit of the buffer and the initial read position of the buffer as recorded by the buffer's entry within the list of abstracted buffers. Any elements represented by the buffer that reside before the initial read position of the buffer as recorded in the buffer's entry are not presently included in the continuous sequence of elements.

In an embodiment, the system removes the buffer from the list of abstracted buffers (Operation 1108). The system removes the buffer from the list of abstracted buffers by deleting the entry corresponding to the buffer in the list of abstracted buffers. Recall that an entry in a list of abstracted buffers may include a strong reference to a buffer that corresponds to that entry. Destroying a strong reference to a buffer may allow the system to reclaim memory space that is occupied by (a) the buffer and (b) an underlying data structure (e.g., an array) that backs the buffer.

In an embodiment, the system determines a number of releasable elements represented by the buffer, and the system adds the number of releasable elements to a tally of elements that are being released from the continuous sequence of elements (Operation 1110). Recall that the release method of the buffers reader deems an element releasable if that element is both (a) read and (b) included in the continuous sequence of elements. Further recall that the buffer is not fully read in this scenario. Therefore, at least some of the elements represented by the buffer will be retained in the continuous sequence of elements. In this scenario, the number of releasable elements represented by the buffer is equal to a differential between the present read position of the buffer and the initial read position of the buffer as recorded by the buffer's entry within the list of abstracted buffers. The number of releasable elements may be zero in this scenario. In an example, the system determines the present read position of the buffer by executing a method offered by the buffer.

In an embodiment, the system updates the aggregated list of buffers maintained by the buffers reader to reflect any elements represented by the buffer that are being released (Operation 1112). In this scenario, at least some of the elements represented by the buffer are not being released. If the number of releasable elements represented by the buffer is zero, the system may choose to skip this operation entirely. In an example, the system updates the aggregated list of buffers by replacing the buffer's previous entry in the list with a new entry. In this example, the new entry includes (a) a reference to the buffer, (b) an updated initial read position of the buffer, and (c) the limit of the buffer. In this example, the updated initial read position of the buffer is the present read position of the buffer.

Prior to updating the aggregated list of buffers maintained by the buffers reader, the system, according to an embodiment, may choose to replace the buffer with a new buffer. The new buffer (a) includes the unread elements represented by the buffer and (b) excludes the read elements represented by the buffer. In an example, the system generates a new buffer by partitioning an original buffer. In this example, the original buffer provides an allocate method, and the system partitions the original buffer by executing the allocate method on the original buffer. Generating the new buffer by partitioning the original buffer may allow memory space occupied by read elements represented by the original buffer to be reclaimed sooner. In another example, the system generates a new buffer by slicing an original buffer. In this example, the original buffer provides a slice method, and the system slices the original buffer by executing the slice method on the original buffer.

In an embodiment, the system determines if there is another buffer in the list of abstracted buffers maintained by the buffers reader that should be evaluated for release, and the system proceeds to another operation based on the determination (Operation 1114). The system evaluates all buffers in the list of abstracted buffers for release, or the system evaluates a portion of the buffers in the list for release. Whether or not iterating through the full list of abstracted buffers is appropriate may depend on (a) the sequence that buffers are added to the list, (b) the organization of the list, (c) the characteristics of the data that is being aggregated, (d) if and how the buffers are processed or sorted prior to addition to the list, (e) and other circumstances of the present application. In any case, if the system determines that there is another buffer in the list of abstracted buffers that should be evaluated for release (YES at Operation 1114), the system returns to Operation 1104 to begin evaluation of that buffer. Alternatively, if the system concludes that there is not another buffer in the list of abstracted buffers that warrants evaluation for release (NO at Operation 1114), the system proceeds to Operation 1116. In an example, the system iterates through the list of abstracted buffers, and the system evaluates the buffers entered in the list for release. In this example, a buffer that is partially read may be entered within the list of abstracted buffers after a buffer that is fully unread. In another example, the system iterates through the list of abstracted buffer starting from the leading buffer in the list, and the system ceases iterating through the list of abstracted buffers upon first encountering a buffer that represents no elements that can be released.

In an embodiment, the system updates variables of the buffers reader as needed to reflect any elements that are being released (Operation 1116). If the running tally of elements is equal to zero, the system may have no need to update any variables of the buffers reader. On the other hand, if the running tally of elements is greater than zero, the system may update (a) a read and released counter of the buffers reader, (b) a start position of the buffers reader, (c) a limit of the buffers reader, (d) a current offset of the buffers reader, (e) a next index of the buffers reader, (f) a current pointer of the buffers reader, and/or (g) other variables of the buffers reader. As an example, assume that the running tally of elements that are being released is equal to ten. In this example, the system increments the read and released counter of the buffers reader by ten, and the system reduces the limit of the buffers reader by ten. Furthermore, in this example, the system sets the current pointer of the buffers reader to null, and the system sets the buffers reader's (a) start position to zero, (b) current offset to zero, (c) next index to zero, and (a) read position to zero.

### 6. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

### 6.1 Example Packet Architecture

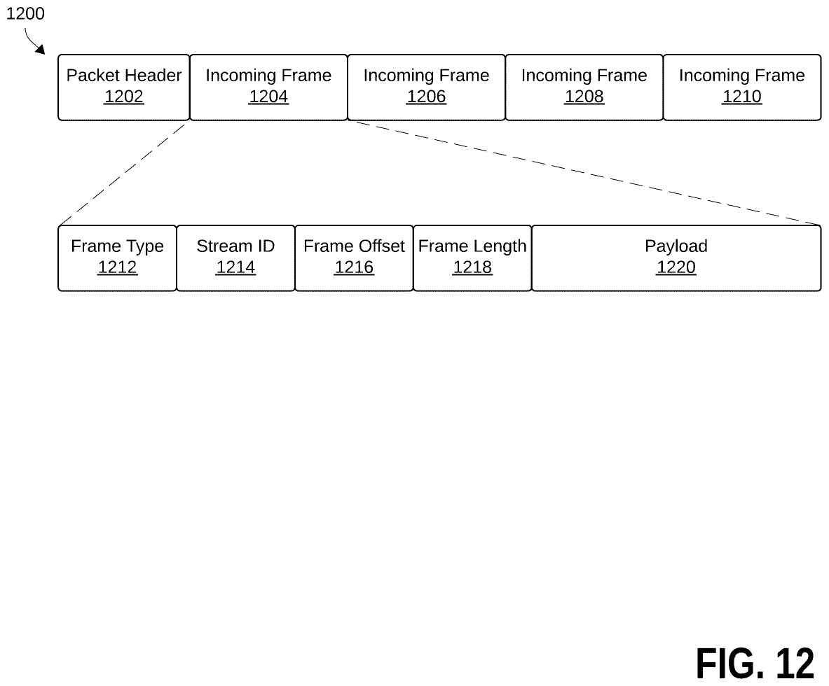

FIG. 12 illustrates a packet 1200 that is transmitted to the system through a network connection in accordance with an example embodiment. As illustrated in FIG. 8, packet 1200 includes packet header 1202, incoming frame 1204, incoming frame 1206, incoming frame 1208, and incoming frame 1210. A packet may include more or fewer components than packet 1200 as illustrated in FIG. 12.

In an example embodiment, packet 1200 is delivered to the system embedded in other unit(s) of stream data. For the purposes of the example illustrated by FIG. 12, assume that packet 1200 is transmitted to the system in accordance with the QUIC protocol. Recall that the QUIC protocol is built on top of UDP. In this example, packet 1200 is delivered to the system in a single UDP datagram (i.e., a UDP packet), or packet 1200 is delivered to the system in multiple UDP datagrams. In this example, packet 1200 may be delivered to the system in an incorrect sequence relative to other packets of the same stream. Furthermore, in this example, one part of packet 1200 embedded into one UDP datagram may be delivered to the system in an incorrect sequence relative to another part of packet 1200 embedded into another UDP datagram.

In an example embodiment, packet 1200 includes packet header 1202, and packet 1200 embeds multiple incoming frames. Packet 1200 delivers incoming frames of a single stream, or packet 1200 delivers incoming frames of multiple streams. The stream data describing an incoming frame included in packet 1200 may be split across one or more other packets.

In an example embodiment, packet header 1202 specifies packet metadata that is used to route packet 1200 to the system. Example packet metadata that may be specified within packet header 1202 includes a header type, a fixed bit, a spin bit, reserved bits, a key phase, a packet number length, a destination connection ID, and/or other information.

In an example embodiment, incoming frame 1204 is a protocol frame carrying stream data. In the example illustrated by FIG. 12, incoming frame 1204 is formatted according to a QUIC protocol. Specifically, incoming frame 1204 is formatted according a stream frame format defined by the QUIC protocol. Accordingly, incoming frame 1204 includes a frame type 1212, a stream ID 1214, a frame offset 1216, a frame length 1218, and a payload 1220. An incoming frame may include more or fewer components than the components of incoming frame 1204 as illustrated in FIG. 12. For instance, if incoming frame 1204 is a different frame type than incoming frame 1206, incoming frame 1204 may include more or fewer components than incoming frame 1206.

In an example embodiment, frame type 1212 is binary data that indicates attributes of incoming frame 1204. In the example illustrated by FIG. 12, frame type 1212 indicates (a) incoming frame 1204 is a QUIC stream frame, (b) incoming frame 1204 includes an offset field (i.e., frame offset 1216), (c) incoming frame 1204 includes a length field (i.e., frame length 1218), and (d) incoming frame 1204 is not the final frame of a stream.

In an example embodiment, stream ID 1214 is binary data that specifies the identify of a stream that incoming frame 1204 belongs to. Recall that packet 1200 may carry incoming frames corresponding to multiple streams. Accordingly, stream ID 1214 may identify a different stream than the stream ID specified in the header of another incoming frame included within packet 1200. For instance, incoming frame 1204 corresponds to the same stream as incoming frame 1206, or incoming frame 1204 corresponds to a different stream than incoming frame 1206.

In an example embodiment, frame offset 1216 is binary data indicating the position of payload 1220 within the stream that is identified by stream ID 1214. In particular, frame offset 1216 indicates a starting position of payload 1220. In the example illustrated by FIG. 12, frame offset 1216 is a byte offset. In other words, frame offset 1216 specifies the address of a byte in this example.

In an example embodiment, frame length 1218 is binary data indicating the size of payload 1220. In the example illustrated by FIG. 12, frame length 1218 specifies a number of bytes occupied by payload 1220.

In an example embodiment, payload 1220 is binary stream data of the stream that is identified by stream ID 1214. Payload 1220 encodes at least part of an outgoing frame. In the example illustrated by FIG. 12, an outgoing frame encoded to payload 1220 may be an HTTP/3 frame. Payload 1220 may encode a part of an HTTP/3 frame, an entire HTTP/3 frame, and/or multiple HTTP/3 frames. If payload 1220 encodes one part of an HTTP/3 frame, another part of the HTTP/3 frame is embedded in another incoming frame within packet 1200, and/or another part of the HTTP/3 frame is embedded in an incoming frame within another packet.

### 6.2 Example Aggregated Data

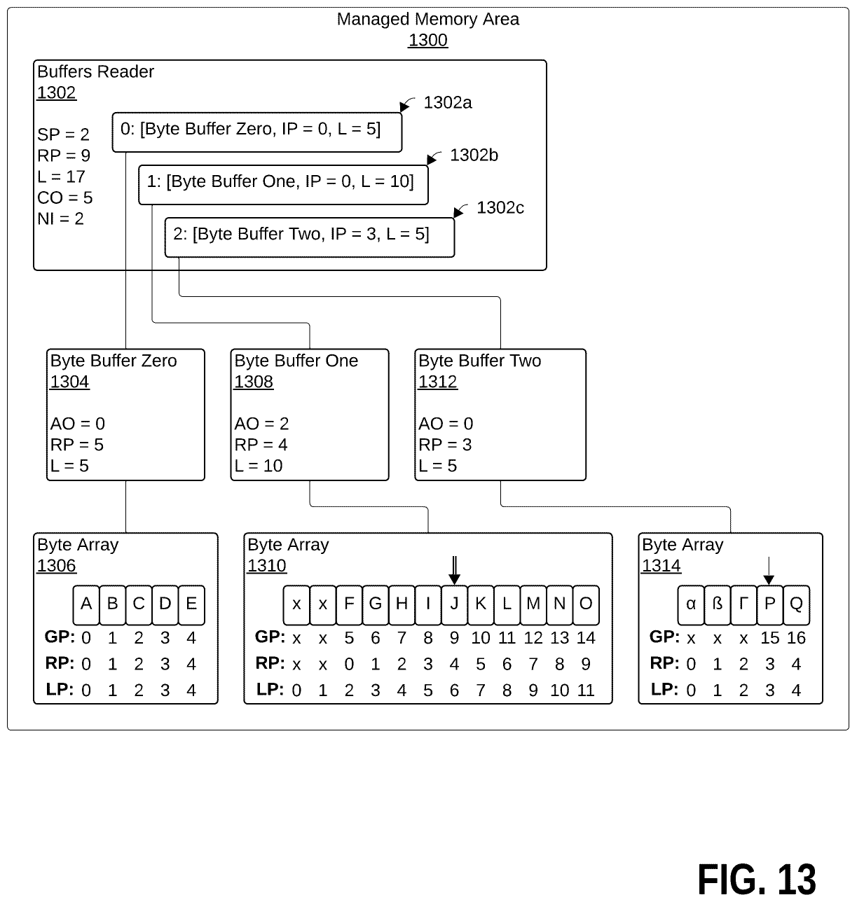

FIG. 13 illustrates an example managed memory area 1300 that may be used for aggregated data in accordance with an example embodiment. As illustrated in FIG. 13, managed memory area 1300 includes buffers reader 1302, byte buffer zero 1304, byte array 1306, byte buffer one 1308, byte array 1310, byte buffer two 1312, and byte array 1314.

In an example embodiment, buffers reader 1302 is a list buffers reader maintaining a list of abstracted byte buffers that includes three entries: entry 1302a, entry 1302b, and entry 1302c. Entry 1302a refers to byte buffer zero 1304, entry 1302b refers to byte buffer one 1308, and entry 1302c refers byte buffer two 1312. Buffers reader 1302 presents a continuous sequence of bytes that includes bytes A through Q. The global positions (GP) of bytes A through Q within the continuous sequence of bytes are zero through sixteen. In the example illustrated by FIG. 13, bytes C through Q are presently accessible through buffers reader 1302. Bytes A and B are not accessible through buffers reader 1302 because bytes A and B reside prior to the start position (SP) of the buffers reader (i.e., two). In the example illustrated by FIG. 13, the read position (RP) of buffers reader 1302 is nine. Therefore, byte J is the first byte in the continuous sequence of bytes that is presently unread. The limit (L) of buffers reader 1302 is seventeen. A current pointer of buffers reader 1302 (not illustrated in FIG. 13) refers to byte buffer one 1308. In other words, byte buffer one 1308 is the current buffer of buffers reader 1302. Accordingly, the current offset (CO) of buffers reader 1302 is five (i.e., the relative offset of byte buffer one 1308). The next index (NI) of buffers reader 1302 is two.

In an example embodiment, entry 1302a is entry number zero in the list of abstracted byte buffers maintained by buffers reader 1302. In other words, entry 1302 is the leading entry in the list of abstracted byte buffers. Entry 1302a includes a reference to byte buffer zero 1304, and entry 1302a specifies an initial read position (IP) of zero and a limit of five. The read position of byte buffer zero 1304 was not zero at the time byte buffer zero 1304 was entered in the list of abstracted byte buffers maintained by buffers reader 1302 (i.e., when entry 1302a was created). As is evidenced by the start position of buffers reader 1302, the read position of byte buffer zero 1304 was two when byte buffer zero 1304 was entered in the list of abstracted byte buffers.

In an example embodiment, entry 1302b is entry number one in the list of abstracted byte buffers maintained by buffers reader 1302. Entry 1302b includes a reference to byte buffer one 1308, and entry 1302b specifies an initial read position of zero and a limit of ten. The initial read position specified by entry 1302b accurately records the read position of byte buffer one 1308 at the time byte buffer one 1308 was entered in the list of abstracted byte buffers maintained by buffers reader 1302.

In an example embodiment, entry 1302c is entry number two in the list of abstracted byte buffers maintained by buffers reader 1302. The index value of entry 1302c (i.e., two) matches the next index of buffers reader 1302. Entry 1302c includes a reference to byte buffer two 1314, and entry 1302c specifies an initial read position of three and a limit of five. The initial read position specified by entry 1302c accurately records the read position of byte buffer two 1312 at the time byte buffer two 1312 was entered in the list of abstracted byte buffers maintained by buffers reader 1302.

In an example embodiment, byte buffer zero 1304 represents bytes A through E. Byte buffer zero 1304 is backed by byte array 1306, and byte array 1306 stores bytes A through E. The relative positions (RP) of bytes A through E are zero through four. Byte buffer zero 1304 corresponds to the leading entry in the list of abstracted byte buffers (i.e., entry 1302a). Therefore, the relative offset and index differential of byte buffer zero 1304 are both zero. As a result, the relative positions of bytes A through E coincide with the global positions of bytes A through E. The relative positions of bytes A through E also coincide with the local positions (LP) of bytes A through E because the array offset (AO) of byte buffer zero 1304 is also zero. In the example illustrated by FIG. 13, byte buffer zero 1304 is fully read because (a) the read position of byte buffer zero 1304 is five, and (b) the limit of byte buffer zero 1304 is five.

In an example embodiment, byte buffer one 1308 is backed by byte array 1310. Byte buffer one 1308 represents bytes F through O, and byte F through O are stored in byte array 1310. The relative positions of bytes F through O are zero through nine. The relative offset of byte buffer one 1310 is five (i.e., the limit of byte buffer zero 1304 minus the initial read position of byte buffer zero 1304 as recorded by entry 1302a). The index differential of byte buffer one 1308 is also equal to five (i.e., the relative offset of byte buffer one 1308 plus the initial read position of byte buffer one 1308). Therefore, the relative positions of bytes F through O differ from the global positions of bytes F through O by five. The relative positions of bytes F through O also differ from the local positions of byte F through O by two because the array offset of byte buffer one 1308 is two. In the example illustrated by FIG. 13, byte buffer one 1308 is partially read because (a) the read position of byte buffer one 1308 is four, and (b) the limit of byte buffer one 1308 is ten.

In an example embodiment, byte buffer two 1312 represents bytes α, ß, Γ, P and Q. Byte buffer two is backed by byte array 1314, and byte array 1314 stores bytes α, ß, Γ, P and Q. The relative position of α, ß, Γ, P and Q are zero through four. Bytes α, ß, and Γ do not have global positions because these bytes were already read when byte buffer two 1312 was added to buffers reader 1302. Therefore, bytes α, ß, and Γ are not included in the continuous sequence of bytes presented by buffers reader 1302. The relative offset of byte buffer two 1312 is fifteen (i.e., the relative offset of byte buffer one 1308 plus the limit of byte buffer one 1308 minus the initial read position of byte buffer one 1308 as recoded by entry 1302c). The index differential of byte buffer two 1312 is twelve (i.e., the relative offset of byte buffer two 1312 minus the initial read position of byte buffer two 1312 as recoded by entry 1302c). Therefore, the relative positions of bytes P and Q differ from the global positions of bytes P and Q by twelve. The relative positions of bytes α, ß, Γ, P and Q do not differ from the local positions of bytes α, ß, Γ, P and Q because the array offset of byte buffer two 1312 is zero. In the example illustrated by FIG. 13, byte buffer two 1312 is partially read because (a) the read position of byte buffer 1312 is three, and (b) the limit of byte buffer two 1312 is five.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

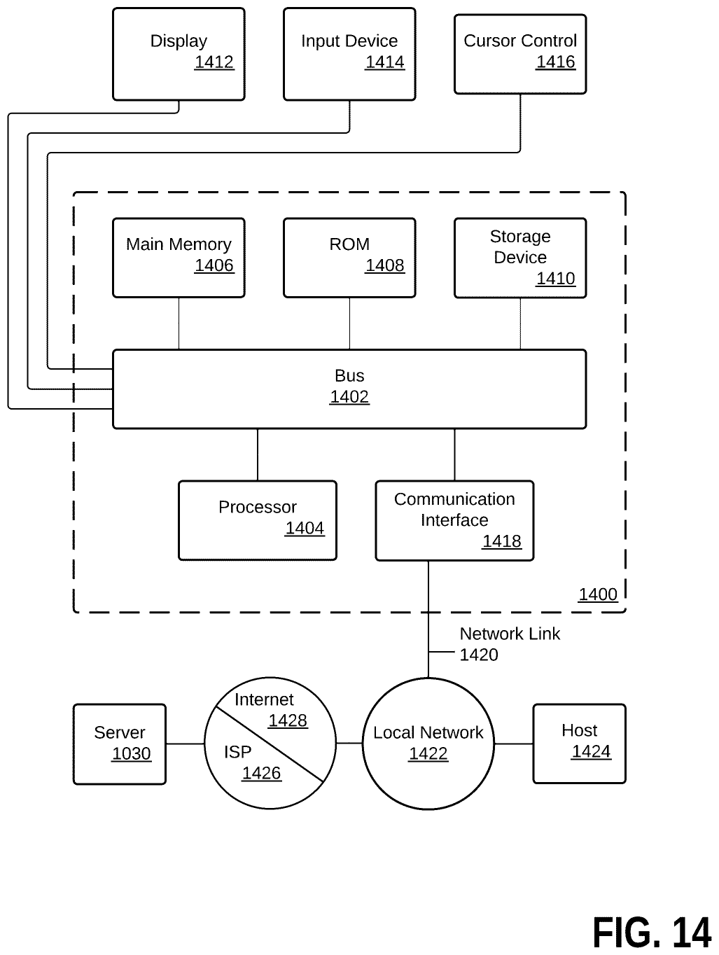

For example, FIG. 14 is a block diagram that illustrates a computer system 1400 upon which an embodiment of the disclosure may be implemented. Computer system 1400 includes a bus 1402 or other communication mechanism for communicating information, and a hardware processor 1404 coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information e79 and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving a first plurality of frames associated with a first protocol, the first plurality of frames embedding a set of one or more frames associated with a second protocol, wherein the set of one or more frames comprises a particular frame;
generating a plurality of runtime objects to represent data comprised within the first plurality of frames, the plurality of runtime objects comprising a first runtime object and a second runtime object,
wherein a first portion of the particular frame is represented by the first runtime object, and a second portion of the particular frame is represented by the second runtime object;
generating, based on the plurality of runtime objects, a single runtime object that presents the first portion of the particular frame and the second portion of the particular frame as a continuous sequence of data; and
decoding the continuous sequence of data to extract the particular frame from the first plurality of frames,
wherein the method is performed by at least one device including a hardware processor.

2. The method of claim 1, wherein decoding the continuous sequence of data to extract the particular frame from the first plurality of frames comprises:
retrieving a first dataset comprised within the first portion of the particular frame;
advancing a first read position associated with the first runtime object by a first amount, the first amount corresponding to a first size of the first dataset;
advancing a read position associated with the single runtime object by the first amount;
retrieving a second dataset comprised within the second portion of the particular frame;
advancing a second read position associated with the second runtime object by a second amount, the second amount corresponding to a second size of the second dataset; and
advancing the read position associated with the single runtime object by the second amount.

3. The method of claim 1, wherein generating the single runtime object comprises:
adding a first entry corresponding to the first runtime object to a list of runtime objects abstracted by the single runtime object,
wherein the first runtime object is associated with a first read limit, and the list of runtime objects abstracted by the single runtime object comprises one or more entries subsequent to the first entry being added to the list;
increasing a third read limit associated with the single runtime object by a first value, wherein the first value is equal to or less than the first read limit;
adding a second entry corresponding to the second runtime object to the list of runtime objects abstracted by the single runtime object, wherein the second runtime object is associated with a second read limit; and
increasing the third read limit associated with the single runtime object by a second value, wherein the second value is equal to or less than the second read limit.

4. The method of claim 3, further comprising:
subsequent to decoding a first part of the continuous sequence of data comprising the first portion of the particular frame:
removing the first entry from the list of runtime objects abstracted by the single runtime object, wherein the first entry comprises a third read position of the first runtime object and the first read limit of the first runtime object; and
decreasing the third read limit of the single runtime object by the first value;
subsequent to decoding a second part of the continuous sequence of data comprising the second portion of the particular frame:
removing the second entry from the list of runtime objects abstracted by the single runtime object, wherein the second entry comprises a fourth read position of the second runtime object and the second read limit of the second runtime object; and
decreasing the third read limit of the single runtime object by the second value.

5. The method of claim 4:
wherein the first read limit corresponds to a first size of the first portion of the particular frame;
wherein the second read limit corresponds to a second size of the second portion of the particular frame;
wherein the first value is equal to the first read limit of the first runtime object minus the third read position of the first runtime object;
wherein the second value is equal the second read limit of the second runtime object minus the fourth read position of the second runtime object;
wherein the first entry precedes the second entry in the list of runtime objects abstracted by the single runtime object;
wherein the third read position is at least one of (a) equal to a first read position of the first runtime object when the first entry is added to the list of runtime objects abstracted by the single runtime object or (b) zero; and
wherein the fourth read position is equal to a second read position of the second runtime object when the second entry is added to the list of runtime objects abstracted by the single runtime object.

6. The method of claim 2, further comprising:
prior to decoding the continuous sequence of data to extract the particular frame from the first plurality of frames:
retrieving a third dataset comprised within the particular frame, wherein the read position of the single runtime object is not advanced by a third amount corresponding to a third size of the third dataset prior to retrieving the first amount of data.

7. The method of claim 6 wherein the first runtime object corresponds to a first entry comprised within in a list of runtime objects abstracted by the single runtime object, wherein the second runtime object corresponds to a second entry comprised within the list of runtime objects abstracted by the single runtime object, wherein the first entry precedes the second entry within the list of runtime objects abstracted by the single runtime object, wherein the first dataset is retrieved prior to the second dataset, wherein the first entry comprises a third read position of the first runtime object and a first read limit of the first runtime object, wherein the second entry comprises a fourth read position of the second runtime object and a second read limit of the second runtime object, wherein the third dataset is comprised within the second portion of the particular frame, wherein the third dataset is retrieved from a particular position associated with second runtime object, and further comprising:
determining the particular position based on at least one of: (a) the first read limit of the first runtime object, (b) the third read position of the first runtime object, or (c) the fourth read position of the second runtime object.

8. The method of claim 1:
wherein a first set of one or more elements comprises the first portion of the particular frame, wherein a second set of one or more elements comprises the second portion of the particular frame;
wherein the first set of one or more elements is indexed according to a first index associated with the first runtime object;
wherein the second set of one or more elements is indexed according to a second index associated with the second runtime object;
wherein the continuous sequence of data is a plurality of elements that are consecutively indexed according to a third index associated with the single runtime object; and
wherein the plurality of elements comprises (a) at least part of the first set of one or more elements and (b) at least part of the second set of one or more elements.

9. The method of claim 8:
wherein the second set of one or more elements comprises a second element;
wherein the second element is associated with a second index value of the second index;
wherein the second element is associated with a third index value of the third index; and wherein the second index value is not equal to the third index value.

10. The method of claim 9, wherein the plurality of elements that are consecutively indexed according to the third index does not comprise at least one of: (a) a first part of the first set of one or more elements or (b) a second part of the second set of one or more elements.

11. The method of claim 1:
wherein the first protocol is a lower-layer protocol;
wherein the second protocol is a higher-layer protocol;
wherein the data comprised within the first plurality of frames comprises binary data;
wherein the first portion of the particular frame is comprised within a first set of one or more bytes delivered by a first lower-layer frame;
wherein the second portion of the particular frame is comprised within a second set of one or more bytes delivered by a second lower-layer frame;
wherein the continuous sequence of data is a plurality of consecutively indexed bytes; and
wherein the plurality of consecutively indexed bytes comprises (a) at least part of the first set of one or more bytes and (b) at least part of the second set of one or more bytes.

12. One or more non-transitory computer-readable media comprising instructions that, when executed by one or more hardware processors, cause performance of operations comprising:
receiving a first plurality of frames associated with a first protocol, the first plurality of frames embedding a set of one or more frames associated with a second protocol, wherein the set of one or more frames comprises a particular frame;
generating a plurality of runtime objects to represent data comprised within the first plurality of frames, the plurality of runtime objects comprising a first runtime object and a second runtime object,
wherein a first portion of the particular frame is represented by the first runtime object, and a second portion of the particular frame is represented by the second runtime object;
generating, based on the plurality of runtime objects, a single runtime object that presents the first portion of the particular frame and the second portion of the particular frame as a continuous sequence of data; and
decoding the continuous sequence of data to extract the particular frame from the first plurality of frames.

13. The one or more non-transitory computer-readable media of claim 12, wherein decoding the continuous sequence of data to extract the particular frame from the first plurality of frames comprises:
retrieving a first dataset comprised within the first portion of the particular frame;
advancing a first read position associated with the first runtime object by a first amount, the first amount corresponding to a first size of the first dataset;
advancing a read position associated with the single runtime object by the first amount;
retrieving a second dataset comprised within the second portion of the particular frame;
advancing a second read position associated with the second runtime object by a second amount, the second amount corresponding to a second size of the second dataset; and
advancing the read position associated with the single runtime object by the second amount.

14. The one or more non-transitory computer-readable media of claim 12, wherein generating the single runtime object comprises:
adding a first entry corresponding to the first runtime object to a list of runtime objects abstracted by the single runtime object,
wherein the first runtime object is associated with a first read limit, and the list of runtime objects abstracted by the single runtime object comprises one or more entries subsequent to the first entry being added to the list;
increasing a third read limit associated with the single runtime object by a first value, wherein the first value is equal to or less than the first read limit;
adding a second entry corresponding to the second runtime object to the list of runtime objects abstracted by the single runtime object, wherein the second runtime object is associated with a second read limit; and
increasing the third read limit associated with the single runtime object by a second value, wherein the second value is equal to or less than the second read limit.

15. The one or more non-transitory computer-readable media of claim 14, wherein the operations further comprise:
subsequent to decoding a first part of the continuous sequence of data comprising the first portion of the particular frame:
removing the first entry from the list of runtime objects abstracted by the single runtime object, wherein the first entry comprises a third read position of the first runtime object and the first read limit of the first runtime object; and
decreasing the third read limit of the single runtime object by the first value;
subsequent to decoding a second part of the continuous sequence of data comprising the second portion of the particular frame:
removing the second entry from the list of runtime objects abstracted by the single runtime object, wherein the second entry comprises a fourth read position of the second runtime object and the second read limit of the second runtime object; and
decreasing the third read limit of the single runtime object by the second value.

16. The one or more non-transitory computer-readable media of claim 15:
wherein the first read limit corresponds to a first size of the first portion of the particular frame;
wherein the second read limit corresponds to a second size of the second portion of the particular frame;
wherein the first value is equal to the first read limit of the first runtime object minus the third read position of the first runtime object;
wherein the second value is equal the second read limit of the second runtime object minus the fourth read position of the second runtime object;
wherein the first entry precedes the second entry in the list of runtime objects abstracted by the single runtime object;
wherein the third read position is at least one of (a) equal to a first read position of the first runtime object when the first entry is added to the list of runtime objects abstracted by the single runtime object or (b) zero; and
wherein the fourth read position is equal to a second read position of the second runtime object when the second entry is added to the list of runtime objects abstracted by the single runtime object.

17. The one or more non-transitory computer-readable media of claim 13, wherein the operations further comprise:
prior to decoding the continuous sequence of data to extract the particular frame from the first plurality of frames:
retrieving a third dataset comprised within the particular frame, wherein the read position of the single runtime object is not advanced by a third amount corresponding to a third size of the third dataset prior to retrieving the first amount of data.

18. The one or more non-transitory computer-readable media of claim 17, wherein the first runtime object corresponds to a first entry comprised within in a list of runtime objects abstracted by the single runtime object, wherein the second runtime object corresponds to a second entry comprised within the list of runtime objects abstracted by the single runtime object, wherein the first entry precedes the second entry within the list of runtime objects abstracted by the single runtime object, wherein the first dataset is retrieved prior to the second dataset, wherein the first entry comprises a third read position of the first runtime object and a first read limit of the first runtime object, wherein the second entry comprises a fourth read position of the second runtime object and a second read limit of the second runtime object, wherein the third dataset is comprised within the second portion of the particular frame, wherein the third dataset is retrieved from a particular position associated with second runtime object, and further comprising:
determining the particular position based on at least one of: (a) the first read limit of the first runtime object, (b) the third read position of the first runtime object, or (c) the fourth read position of the second runtime object.

19. The one or more non-transitory computer-readable media of claim 12:
wherein the first protocol is a lower-layer protocol;
wherein the second protocol is a higher-layer protocol;
wherein the data comprised within the first plurality of frames comprises binary data;
wherein the first portion of the particular frame is comprised within a first set of one or more bytes delivered by a first lower-layer frame;
wherein the second portion of the particular frame is comprised within a second set of one or more bytes delivered by a second lower-layer frame;
wherein the continuous sequence of data is a plurality of consecutively indexed bytes; and
wherein the plurality of consecutively indexed bytes comprises (a) at least part of the first set of one or more bytes and (b) at least part of the second set of one or more bytes.

20. A system comprising:
at least one device including a hardware processor;
the system being configured to perform operations comprising:
receiving a first plurality of frames associated with a first protocol, the first plurality of frames embedding a set of one or more frames associated with a second protocol, wherein the set of one or more frames comprises a particular frame;
generating a plurality of runtime objects to represent data comprised within the first plurality of frames, the plurality of runtime objects comprising a first runtime object and a second runtime object,
wherein a first portion of the particular frame is represented by the first runtime object, and a second portion of the particular frame is represented by the second runtime object;
generating, based on the plurality of runtime objects, a single runtime object that presents the first portion of the particular frame and the second portion of the particular frame as a continuous sequence of data; and
decoding the continuous sequence of data to extract the particular frame from the first plurality of frames.
